(19) United States
(12) Patent Application Publication
(10) Pub. No.: US 2024/0328014 A1
(43) Pub. Date: Oct. 3, 2024

(54) AMMONIA PRODUCTION METHOD AND AMMONIA PRODUCTION APPARATUS

(71) Applicants: THE UNIVERSITY OF TOKYO, Tokyo (JP); NISSAN CHEMICAL CORPORATION, Tokyo (JP)

(72) Inventors: Yoshiaki NISHIBAYASHI, Tokyo (JP); Kazuya ARASHIBA, Tokyo (JP); Yuya ASHIDA, Tokyo (JP); Shoichi KONDO, Funabashi-shi (JP); Takamasa KIKUCHI, Funabashi-shi (JP); Norihito SHIGA, Funabashi-shi (JP)

(73) Assignees: THE UNIVERSITY OF TOKYO, Tokyo (JP); NISSAN CHEMICAL CORPORATION, Tokyo (JP)

(21) Appl. No.: 18/285,352

(22) PCT Filed: Mar. 30, 2022
(86) PCT No.: PCT/JP2022/016089

§ 371 Date: Oct. 2, 2023

(30) Foreign Application Priority Data
Mar. 30, 2021 (JP) 2021-058798

(51) Int. Cl. C25B 11/095; C07F 11/00; C25B 1/27; C25B 9/23; C25B 11/032; C25B 11/052

(52) U.S. Cl. CPC C25B 11/095; C07F 11/005; C25B 1/27; C25B 9/23; C25B 11/032; C25B 11/052

(57) ABSTRACT

An ammonia production method is a method that produces ammonia from nitrogen molecules by donating electrons from a power supply, protons from a proton source, and the nitrogen molecules from means for supplying a nitrogen gas in presence of a complex, a solid catalyst, and a reaction field forming material in a cathode by a production apparatus for performing electrolysis. In the complex, the solid catalyst, and the reaction field forming material, for example, a molybdenum complex expressed by Formula (A1-1) is used as the complex.

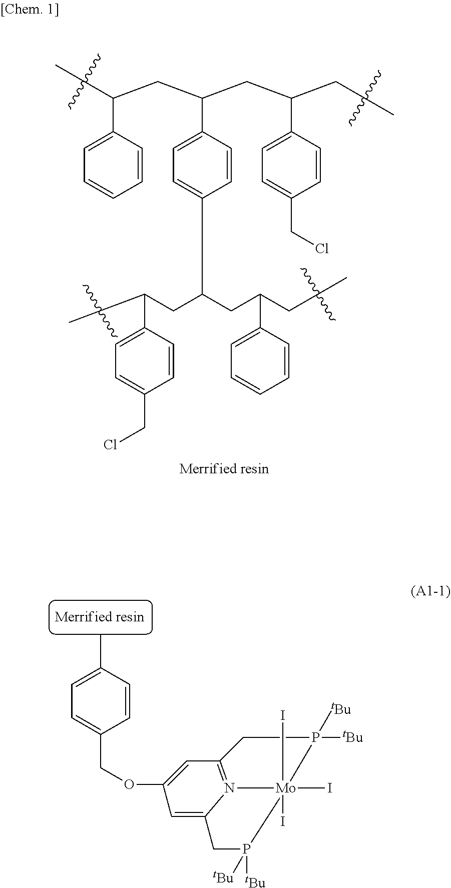

A platinum catalyst is used as the solid catalyst, and a rare earth metal-carbon-based binder is used as the reaction field forming material.

### TECHNICAL FIELD

The present invention relates to an ammonia production method and an ammonia production apparatus.

### BACKGROUND ART

In a method of producing ammonia from nitrogen molecules in a low-temperature region by electrolysis, there is a reported example of producing ammonia by electrolysis at 90° C. using ruthenium supported on a carbon felt as a cathode and a platinum electrode as an anode (Non-Patent Document 1). There is a reported example in which ammonia was produced by electrolysis using Sm_{1.5}Sr_{0.5}CoO₄ and the like in an ammonia generating electrode (Non-Patent Document 2).

Meanwhile, with regard to a reaction of producing ammonia from nitrogen molecules, there has been a reported example using samarium (II) iodide as a reducing agent and using alcohols or water as a proton source when a molybdenum complex is used as a catalyst (Non-Patent Document 3). It has also been reported that ammonia is generated by using a molybdenum complex supported on a polystyrene resin (Non-Patent Document 4).
Non-Patent Document 1: Chem. Commun., 2000, Pages 1673 and 1674
Non-Patent Document 2: Sci. Rep., 2013, Volume 3, Pages 1145 to 1151
Non-Patent Document 3: Nature, 2019, Volume 568, Pages 536 to 540
Non-Patent Document 4: Chem. Lett., 2019, Volume 48, Pages 693 to 695

### DISCLOSURE OF THE INVENTION

### Problems to be Solved by the Invention

In Non-Patent Document 1, while the operation was performed at or around 90 to 100° C. at a low-temperature region, the operation at or around 20 to 30° C. as a room temperature was a challenge. In Non-Patent Document 2, a step of processing a membrane with ammonia before a Nafion membrane used as an electrolyte membrane was incorporated into an electrolytic apparatus was complicated, and it eventually causes uneasy problems from the aspect of recycle of the electrolytic apparatus.

There is a need for using samarium (II) iodide as the reducing agent in Non-Patent Document 3, and there is a need for using decamethylcobaltocene as the reducing agent in Non-Patent Document 4. Since the amount of the reducing agent at that time is an equivalent weight of 3 per 1 equivalent weight of the ammonia, from a practical point of view, there was a problem that recovery or recycle of these reducing agents was not easy.

In order to solve the problems described above, a main object of the present invention is a method of electrochemically producing ammonia without using a reducing agent that avoids pretreatment of an electrolyte membrane and operates at or around 20 to 30° C. as a room temperature.

### SOLUTIONS TO THE PROBLEMS

To achieve the above-described object, the present inventors have found that, by using a complex represented by a molybdenum complex or the like, a solid catalyst represented by a metal catalyst, an oxide catalyst, or the like, and further a reaction field forming material in combination, ammonia can be produced electrochemically, the amount of generated ammonia can be improved, and a decrease in the amount of increase of generated ammonia as the reaction time progresses can be suppressed, thereby completing the present invention. Non-Patent Documents 1 and 2 described above are the reported examples of the electrochemical productions of ammonia using the solid catalysts, and there is no reported example of electrochemical production of ammonia that prepares a membrane electrode assembly or a gas diffusion electrode in a combination of a complex and a solid catalyst for use.

The present invention based on the knowledges are, for example, as follows.
[1] An ammonia production method produces ammonia from nitrogen molecules by donating electrons from a power supply, protons from a proton source, and the nitrogen molecules from means for supplying a nitrogen gas in presence of a complex, a solid catalyst, and a reaction field forming material in a cathode by a production apparatus for performing electrolysis.

The complex is:
(A) a molybdenum complex having 2,6-bis(dialkylphosphinomethyl)pyridine (where two alkyl groups may be identical or different, and at least one hydrogen atom on a pyridine ring may be substituted with an alkyl group, an alkoxy group, or a halogen atom) as a PNP ligand;
(B) a molybdenum complex having N,N-bis(dialkylphosphinomethyl) dihydrobenzimidazolidene (where two alkyl groups may be identical or different, and at least one hydrogen atom on a benzene ring may be substituted with an alkyl group, an alkoxy group, or a halogen atom) as a PCP ligand;
(C) a molybdenum complex having bis(dialkylphosphinoethyl) arylphosphine (where two alkyl groups may be identical or different) as a PPP ligand; or
(D) a molybdenum complex expressed as trans-Mo(N₂)₂(R⁵R⁶R⁷P)₄ (where R⁵ and R⁶ are aryl groups that may be identical or different, R′ is an alkyl group, and two R⁷ groups may be connected with one another to form an alkylene chain).

The solid catalyst is a metal catalyst or an oxide catalyst.

The proton source is an electrolyte membrane, an electrolytic solution, or both of the electrolyte membrane and the electrolytic solution.
[2] In the ammonia production method according to [1], the molybdenum complex (A) is a molybdenum complex expressed by the following Formula (A1), (A2), or (A3):

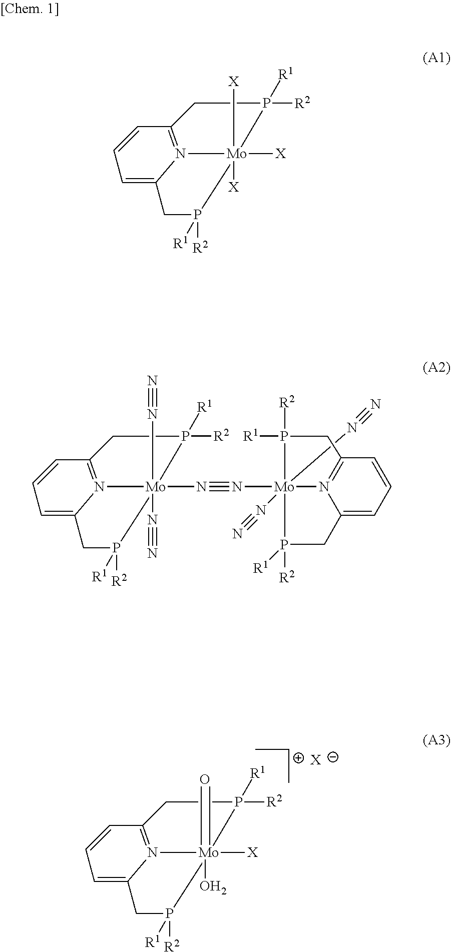

(In the formula, R¹ and R² are alkyl groups that may be identical or different, X is an iodine atom, a bromine atom, or a chlorine atom, and at least one hydrogen atom on a pyridine ring may be substituted with an alkyl group, an alkoxy group, or a halogen atom).
[3] In the ammonia production method according to [1], the molybdenum complex (B) is a molybdenum complex expressed by the following Formula (B1) or (B2):

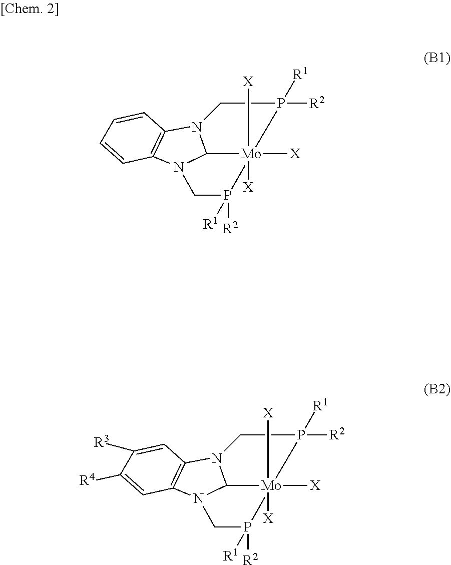

(In the formula, R¹ and R² are alkyl groups that may be identical or different, X is an iodine atom, a bromine atom, or a chlorine atom, at least one hydrogen atom on a benzene ring may be substituted with an alkyl group, an alkoxy group, or a halogen atom, and at least one of R³ and R⁴ is substituted with a trifluoromethyl group).
[4] In the ammonia production method according to [1], the molybdenum complex (C) is a molybdenum complex expressed by Formula (C1):

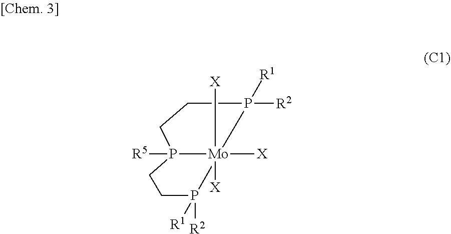

(In the formula, R¹ and R² are alkyl groups that may be identical or different, R⁵ is an aryl group, and X is an iodine atom, a bromine atom, or a chlorine atom).
[5] In the ammonia production method according to [1], the molybdenum complex (D) is a molybdenum complex expressed by Formula (D1) or (D2):

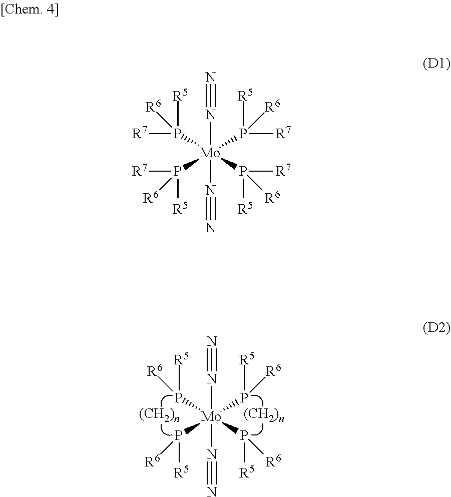

(In the formula, R⁵ and R⁶ are aryl groups that may be identical or different, R⁷ is an alkyl group, and n is 2 or 3).
[6] In the ammonia production method according to any of [1] to [5], the solid catalyst is a platinum catalyst or a palladium catalyst.
[7] In a membrane electrode assembly, an electrolyte membrane is sandwiched between a cathode catalyst layer and an anode catalyst layer to assemble together.

The cathode catalyst layer contains a complex and a cathode solid catalyst.

The anode catalyst layer contains an anode solid catalyst.

The complex is:
(A) a molybdenum complex having 2,6-bis(dialkylphosphinomethyl) pyridine (where two alkyl groups may be identical or different, and at least one hydrogen atom on a pyridine ring may be substituted with an alkyl group, an alkoxy group, or a halogen atom) as a PNP ligand;
(B) a molybdenum complex having N,N-bis(dialkylphosphinomethyl) dihydrobenzimidazolidene (where two alkyl groups may be identical or different, and at least one hydrogen atom on a benzene ring may be substituted with an alkyl group, an alkoxy group, or a halogen atom) as a PCP ligand;
(C) a molybdenum complex having bis(dialkylphosphinoethyl) arylphosphine (where two alkyl groups may be identical or different) as a PPP ligand; or
(D) a molybdenum complex expressed as trans-Mo(N₂)₂(R⁵R⁶R⁷P)₄ (where R⁵ and R⁶ are aryl groups that may be identical or different, R′ is an alkyl group, and two R⁷ groups may be connected with one another to form an alkylene chain).

The cathode solid catalyst and the anode solid catalyst are metal catalysts or oxide catalysts.
[8] In the membrane electrode assembly according to [7], the molybdenum complex (A) is a molybdenum complex expressed by the following Formula (A1), (A2), or (A3):

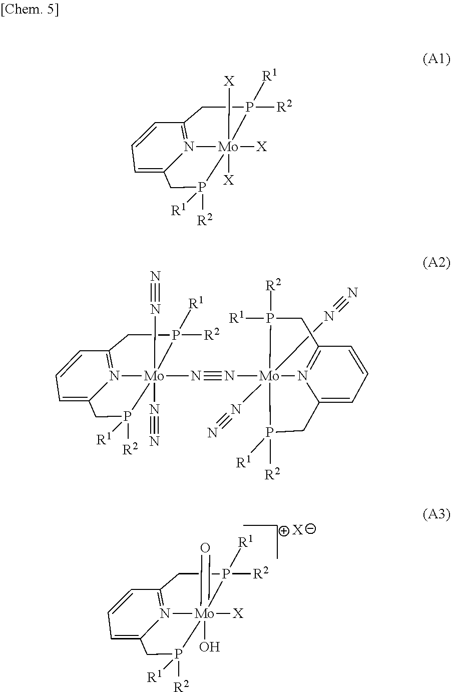

(In the formula, R¹ and R² are alkyl groups that may be identical or different, X is an iodine atom, a bromine atom, or a chlorine atom, and at least one hydrogen atom on a pyridine ring may be substituted with an alkyl group, an alkoxy group, or a halogen atom).
[9] In the membrane electrode assembly according to [7], the molybdenum complex (B) is a molybdenum complex expressed by the following Formula (B1) or (B2):

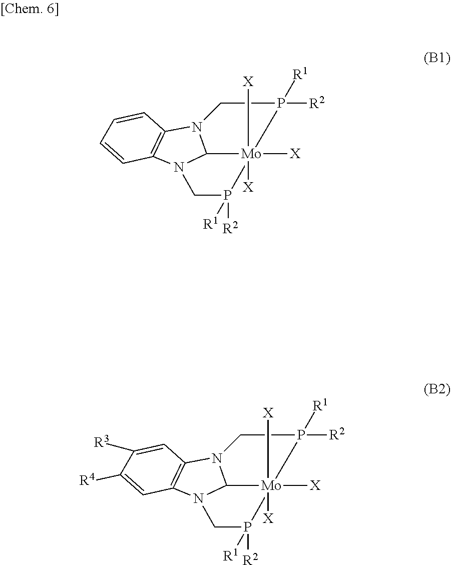

(In the formula, R¹ and R² are alkyl groups that may be identical or different, X is an iodine atom, a bromine atom, or a chlorine atom, at least one hydrogen atom on a benzene ring may be substituted with an alkyl group, an alkoxy group, or a halogen atom, and at least one of R³ and R⁴ is substituted with a trifluoromethyl group).
[10] In the membrane electrode assembly according to [7], the molybdenum complex (C) is a molybdenum complex expressed by Formula (C1):

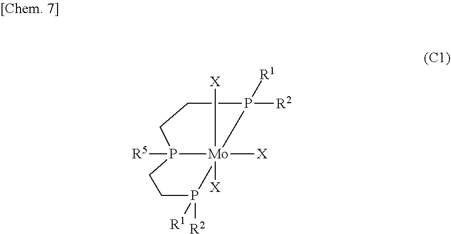

(In the formula, R¹ and R² are alkyl groups that may be identical or different, R⁵ is an aryl group, and X is an iodine atom, a bromine atom, or a chlorine atom).
[11] In the membrane electrode assembly according to [7], the molybdenum complex (D) is a molybdenum complex expressed by Formula (D1) or (D2):

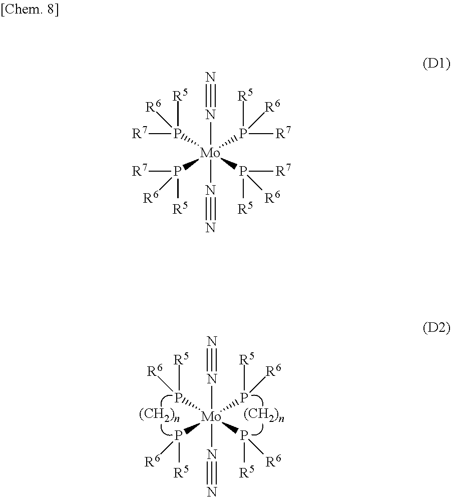

(In the formula, R⁵ and R⁶ are aryl groups that may be identical or different, R′ is an alkyl group, and n is 2 or 3).
[12] In the membrane electrode assembly according to any of [7] to [11], the cathode solid catalyst is a platinum catalyst or a palladium catalyst.
[13] An ammonia production apparatus includes the membrane electrode assembly according to any of [7] to [12]. The membrane electrode assembly includes the cathode catalyst layer, the electrolyte membrane, and the anode catalyst layer.

In a cathode, the cathode catalyst layer is assembled to one side of the electrolyte membrane and a cathode current collector is disposed outside the cathode catalyst layer, and in an anode, the anode catalyst layer is assembled to the other side of the electrolyte membrane and an anode current collector is disposed outside the anode catalyst layer.

The cathode includes the cathode catalyst layer and the cathode current collector.

The anode includes the anode catalyst layer and the anode current collector.

The ammonia production apparatus includes:
a cathode electrolytic solution tank in liquid contact with the cathode.
an anode electrolytic solution tank in liquid contact with the anode.
a power supply that supplies the cathode with electrons.
a proton source that supplies the cathode with protons; and
means that supplies a cathode electrolytic solution or the cathode with a nitrogen gas.

The proton source is the electrolyte membrane, an anode electrolytic solution, or both of the electrolyte membrane and the anode electrolytic solution.

Ammonia is produced from nitrogen molecules by electrolysis.
[14] An ammonia production apparatus includes the membrane electrode assembly according to any of [7] to [12]. The membrane electrode assembly includes the cathode catalyst layer, the electrolyte membrane, and the anode catalyst layer.

In a cathode, the cathode catalyst layer is assembled to one side of the electrolyte membrane and a cathode current collector is disposed outside the cathode catalyst layer, and in an anode, the anode catalyst layer is assembled to the other side of the electrolyte membrane and an anode current collector is disposed outside the anode catalyst layer.

The cathode includes the cathode catalyst layer and the cathode current collector.

The anode includes the anode catalyst layer and the anode current collector.

The ammonia production apparatus includes:
an anode electrolytic solution tank of an anode electrolytic solution in liquid contact with the anode of the membrane electrode assembly.
a power supply that supplies the cathode with electrons.
a proton source that supplies the cathode with protons; and
means that supplies the cathode with a nitrogen gas.

The proton source is the electrolyte membrane, an electrolytic solution, or both of the electrolyte membrane and the electrolytic solution.

Ammonia is produced from nitrogen molecules by electrolysis.
[15] A gas diffusion electrode contains a complex and a cathode solid catalyst.

The complex is:
(A) a molybdenum complex having 2,6-bis(dialkylphosphinomethyl) pyridine (where two alkyl groups may be identical or different, and at least one hydrogen atom on a pyridine ring may be substituted with an alkyl group, an alkoxy group, or a halogen atom) as a PNP ligand;
   (B) a molybdenum complex having N,N-bis(dialkylphosphinomethyl) dihydrobenzimidazolidene (where two alkyl groups may be identical or different, and at least one hydrogen atom on a benzene ring may be substituted with an alkyl group, an alkoxy group, or a halogen atom) as a PCP ligand;
   (C) a molybdenum complex having bis(dialkylphosphinoethyl) arylphosphine (where two alkyl groups may be identical or different) as a PPP ligand; or
   (D) a molybdenum complex expressed as trans-Mo(N₂)₂(R⁵R⁶R⁷P)₄ (where R⁵ and R⁶ are aryl groups that may be identical or different, R⁷ is an alkyl group, and two R⁷ groups may be connected with one another to form an alkylene chain).

The cathode solid catalyst is a metal catalyst or an oxide catalyst.
[16] In the gas diffusion electrode according to [15], the molybdenum complex (A) is a molybdenum complex expressed by the following Formula (A1), (A2), or (A3):

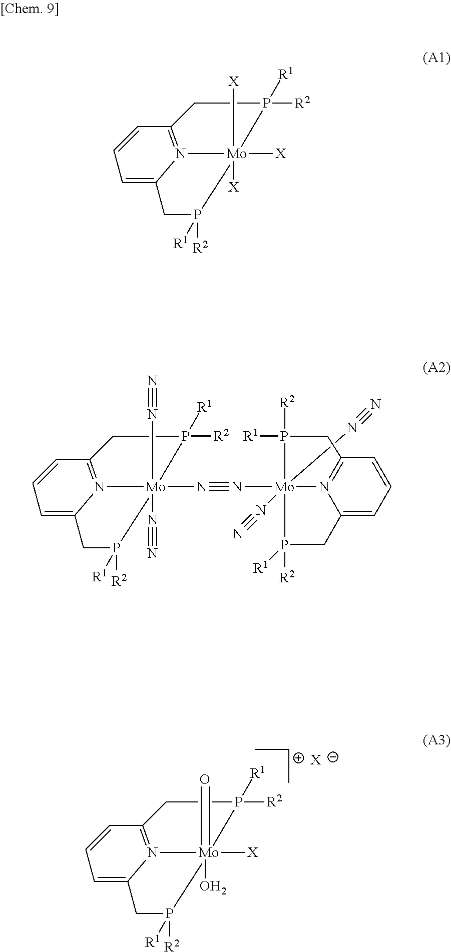

(In the formula, R¹ and R² are alkyl groups that may be identical or different, X is an iodine atom, a bromine atom, or a chlorine atom, and at least one hydrogen atom on a pyridine ring may be substituted with an alkyl group, an alkoxy group, or a halogen atom).
[17] In the gas diffusion electrode according to [15], the molybdenum complex (B) is a molybdenum complex expressed by the following Formula (B1) or (B2):

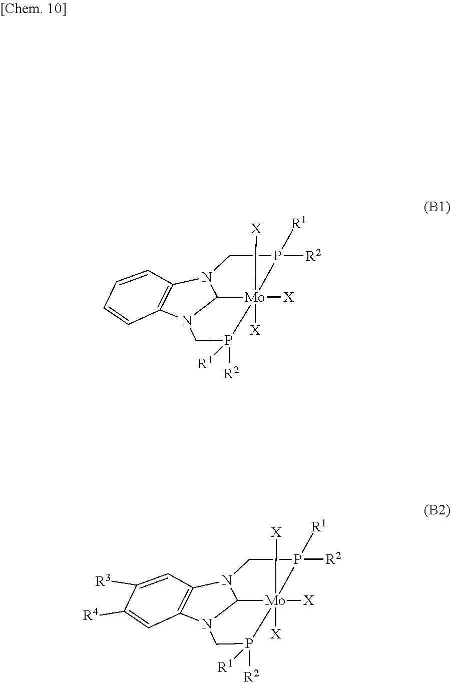

(In the formula, R¹ and R² are alkyl groups that may be identical or different, X is an iodine atom, a bromine atom, or a chlorine atom, at least one hydrogen atom on a benzene ring may be substituted with an alkyl group, an alkoxy group, or a halogen atom, and at least one of R³ and R⁴ is substituted with a trifluoromethyl group).
[18] In the gas diffusion electrode according to [15], the molybdenum complex (C) is a molybdenum complex expressed by Formula (C1):

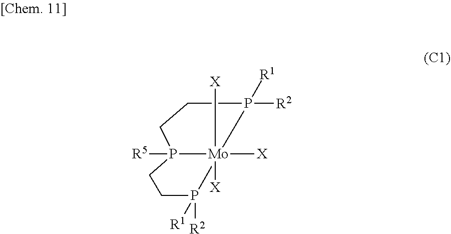

(In the formula, R¹ and R² are alkyl groups that may be identical or different, R⁵ is an aryl group, and X is an iodine atom, a bromine atom, or a chlorine atom).
[19] In the gas diffusion electrode according to [15], the molybdenum complex (D) is a molybdenum complex expressed by Formula (D1) or (D2):

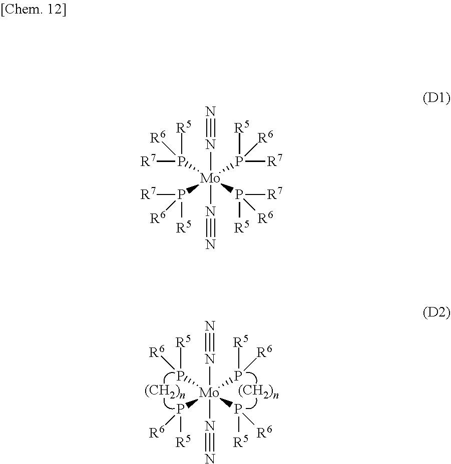

(In the formula, R⁵ and R⁶ are aryl groups that may be identical or different, R⁷ is an alkyl group, and n is 2 or 3).
[20] In the gas diffusion electrode according to any of [15] to [19], the cathode solid catalyst is a platinum catalyst or a palladium catalyst.
[21] An ammonia production apparatus includes:
   the gas diffusion electrode as the cathode catalyst layer according to any of [15] to [20];
   a tank of an electrolytic solution in which a cathode current collector is disposed at one side of the cathode catalyst layer as the gas diffusion electrode in which the electrolytic solution tank is in liquid contact with the cathode catalyst layer;
   a cathode that includes the cathode catalyst layer and the cathode current collector;
   an anode that includes a metal plate electrode;
   a power supply that supplies the cathode with electrons;
   a proton source that supplies the cathode with protons; and
   means that supplies the electrolytic solution or the cathode with a nitrogen gas.

The proton source is an electrolytic solution.

Ammonia is produced from nitrogen molecules by electrolysis.
[22] In a cathode membrane electrode assembly in which a cathode catalyst layer is assembled to one side of an electrolyte membrane, the cathode catalyst layer contains a complex and a cathode solid catalyst.

The complex is:
(A) a molybdenum complex having 2,6-bis(dialkylphosphinomethyl) pyridine (where two alkyl groups may be identical or different, and at least one hydrogen atom on a pyridine ring may be substituted with an alkyl group, an alkoxy group, or a halogen atom) as a PNP ligand;
(B) a molybdenum complex having N,N-bis(dialkylphosphinomethyl) dihydrobenzimidazolidene (where two alkyl groups may be identical or different, and at least one hydrogen atom on a benzene ring may be substituted with an alkyl group, an alkoxy group, or a halogen atom) as a PCP ligand;
(C) a molybdenum complex having bis(dialkylphosphinoethyl) arylphosphine (where two alkyl groups may be identical or different) as a PPP ligand; or
(D) a molybdenum complex expressed as trans-Mo(N₂)₂(R⁵R⁶R⁷P)₄ (where R⁵ and Re are aryl groups that may be identical or different, R′ is an alkyl group, and two R⁷ groups may be connected with one another to form an alkylene chain).

The cathode solid catalyst is a metal catalyst or an oxide catalyst.
[23] In the cathode membrane electrode assembly according to [22], the molybdenum complex (A) is a molybdenum complex expressed by the following Formula (A1), (A2), or (A3):

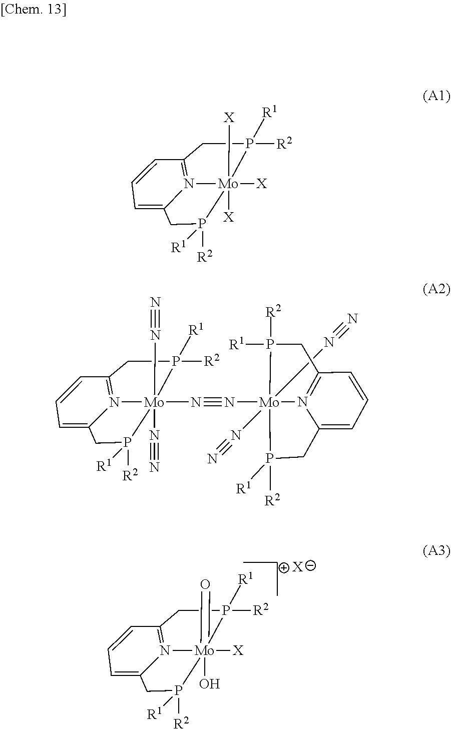

(In the formula, R¹ and R² are alkyl groups that may be identical or different, X is an iodine atom, a bromine atom, or a chlorine atom, and at least one hydrogen atom on a pyridine ring may be substituted with an alkyl group, an alkoxy group, or a halogen atom).
[24] In the cathode membrane electrode assembly according to [22], the molybdenum complex (B) is a molybdenum complex expressed by the following Formula (B1) or (B2):

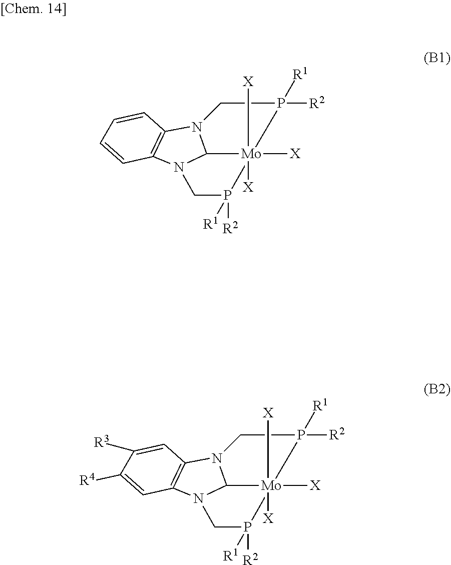

(In the formula, R¹ and R² are alkyl groups that may be identical or different, X is an iodine atom, a bromine atom, or a chlorine atom, at least one hydrogen atom on a benzene ring may be substituted with an alkyl group, an alkoxy group, or a halogen atom, and at least one of R³ and R⁴ is substituted with a trifluoromethyl group).
[25] In the cathode membrane electrode assembly according to [22], the molybdenum complex (C) is a molybdenum complex expressed by Formula (C1):

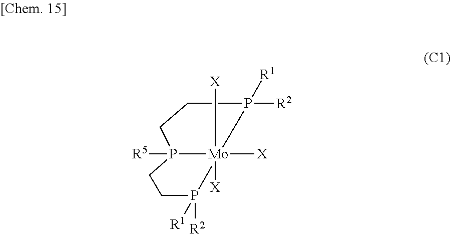

(In the formula, R¹ and R² are alkyl groups that may be identical or different, R⁵ is an aryl group, and X is an iodine atom, a bromine atom, or a chlorine atom).
[26] In the cathode membrane electrode assembly according to [22], the molybdenum complex (D) is a molybdenum complex expressed by Formula (D1) or (D2):

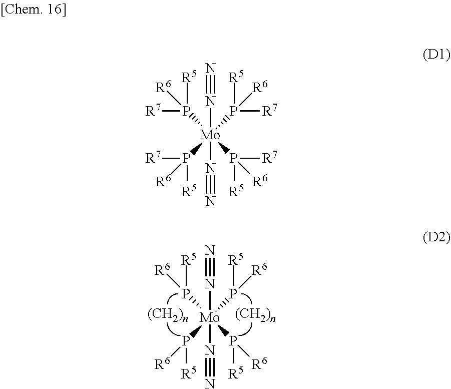

(In the formula, R⁵ and R⁶ are aryl groups that may be identical or different, R⁷ is an alkyl group, and n is 2 or 3).
[27] In the cathode membrane electrode assembly according to any of [22] to [26], the cathode solid catalyst is a platinum catalyst or a palladium catalyst.
[28] An ammonia production apparatus includes:
   the cathode membrane electrode assembly according to any of to [27], the cathode catalyst layer is assembled to one side of the electrolyte membrane;
   a cathode current collector disposed on a side opposite to the electrolyte membrane of the cathode catalyst layer;
   a cathode that includes the cathode catalyst layer and the cathode current collector;
   a tank of an electrolytic solution in liquid contact with the electrolyte membrane;
   an anode that includes a metal plate electrode;
   a power supply that supplies the cathode with electrons;
   a proton source that supplies the cathode with protons; and
   means that supplies the electrolytic solution or the cathode with a nitrogen gas.

The proton source is the electrolyte membrane, an electrolytic solution, or both of the electrolyte membrane and the electrolytic solution.

Ammonia is produced from nitrogen molecules by electrolysis.

### Effects of the Invention

According to the ammonia production method of the present invention, ammonia can be produced from the nitrogen molecules by donating the electrons from the power supply, the protons from the proton source, and the nitrogen molecules from the means for supplying the nitrogen gas in the presence of the complex, the solid catalyst, and the reaction field forming material in the cathode by the production apparatus for performing electrolysis.

### BRIEF DESCRIPTION OF THE DRAWINGS

FIG. 1 is an explanatory view of an electrolytic apparatus of ammonia (first).

FIG. 2 is an explanatory view of an electrolytic apparatus of ammonia (second).

FIG. 3 is an explanatory view of an electrolytic apparatus of ammonia (third).

FIG. 4 is an explanatory view of an electrolytic apparatus of ammonia (fourth).

FIG. 5 is a chart of IR measurement of a calcined body (a1).

FIG. 6 is a chart of IR measurement of Ketjenblack EC (EC300J).

### DESCRIPTION OF PREFERRED EMBODIMENTS

The following describes preferred embodiments of an ammonia production method and an ammonia production apparatus of the present invention.

In this Description, “n-” represents normal, “s-” represents secondary, “t-” represents tertiary, “o-” represents ortho, “m-” represents meta, “p-” represents para, and “Bu” represents a t-butyl group.

Notation of a Cₐ to C_{b} alkyl group in this Description represents a monovalent group generated by losing one atom of hydrogen from a straight-chain, branched-chain, or cyclic aliphatic hydrocarbon having the number of carbon atoms of a to b. Specific examples thereof include a methyl group, an ethyl group, an n-propyl group, an isopropyl group, a cyclopropyl group, an n-butyl group, an isobutyl group, an s-butyl group, a t-butyl group, a cyclobutyl group, an n-pentyl group, an isopentyl group, a neopentyl group, a t-pentyl group, a 1,1-dimethylpropyl group, a cyclopentyl group, an n-hexyl group, an isohexyl group, a 3-methylpentyl group, a 2,2-dimethylbutyl group, a 2,3-dimethylbutyl group, a cyclohexyl group, an n-heptyl group, a 2-methylhexyl group, a 3-ethylpentyl group, an n-octyl group, a 2,2,4-trimethylpentyl group, a 2,5-dimethylhexyl group, an n-nonyl group, a 2,7-dimethyloctyl group, and an n-decyl group. Each of them is set in a range of the specified number of carbon atoms. In “Cₐ to C_{b}” representing the number of carbon atoms, a indicates an integer of one or more, and b indicates an integer of a or more.

Notation of a Cₐ to C_{b} alkoxy group in this Description represents a monovalent group in which the alkyl group in the above-described meaning having the number of carbon atoms a to b binding with oxygen. Specific examples thereof include a methoxy group, an ethoxy group, an n-propoxy group, an isopropoxy group, a cyclopropoxy group, an n-butoxy group, an isobutoxy group, an s-butoxy group, a t-butoxy group, a cyclobutoxy group, an n-pentoxy group, an isopentoxy group, a neopentoxy group, a t-pentoxy group, a 1,1-dimethylpropoxy group, a cyclopentoxy group, an n-hexoxy group, an isohexoxy group, a 3-methylpentoxy group, a 2,2-dimethylbutoxy group, a 2,3-dimethylbutoxy group, a cyclohexoxy group, an n-heptoxy group, a 2-methylhexoxy group, a 3-ethylpentoxy group, an n-octoxy group, a 2,2,4-trimethylpentoxy group, and a 2,5-dimethylhexoxy group. Each of them is set in a range of the specified number of carbon atoms.

Specific examples of halogen atoms in this Description include fluorine atoms, chlorine atoms, bromine atoms, and iodine atoms.

The notation of an Ar₆ aryl group in this Description represents a monovalent group generated by losing one atom of hydrogen from an aromatic ring of an aromatic hydrocarbon having the number of carbon atoms of 6, and examples thereof include a phenyl group, such as a phenyl group having a substituent at at least one of position 2 to position 6. Examples of a substituent on the aromatic ring of Ar₆ aryl include a fluoro group, a chloro group, a bromo group, an iodine group, which are halogen atoms, a methyl group, a trifluoromethyl group, an ethyl group, an n-propyl group, an isopropyl group, an n-butyl group, an isobutyl group, an s-butyl group, and a t-butyl group. Specific examples of the Ar₆ aryl group include a phenyl group, an o-fluorophenyl group, an m-fluorophenyl group, a p-fluorophenyl group, an o-trifluoromethylphenyl group, an m-trifluoromethylphenyl group, a p-trifluoromethylphenyl group, an o-chlorophenyl group, an m-chlorophenyl group, a p-chlorophenyl group, an o-bromophenyl group, an m-bromophenyl group, a p-bromophenyl group, an o-tolyl group, an m-tolyl group, a p-tolyl group, an o-ethylphenyl group, an m-ethylphenyl group, a p-ethylphenyl group, an o-(t-butyl)phenyl group, an m-(t-butyl)phenyl group, a p-(t-butyl)phenyl group, a 3,5-dimethylphenyl group, a 3,5-bistrifluoromethylphenyl group, a 3,4,5-trifluorophenyl group, an o-methoxyphenyl group, an m-methoxyphenyl group, and a p-methoxyphenyl group.

The ammonia production method of this embodiment can be performed in a production apparatus for performing electrolysis. In this Description, the production apparatus for performing electrolysis may be described as an electrolytic apparatus and includes an electrolytic cell, supply means of a nitrogen gas, ammonia recovery means, and exclusion means of an exhaust gas, and details of the electrolytic apparatus will be described later.

The electrolytic cell includes electrodes, an electrolytic solution tank, a supply port for nitrogen gas, and an outlet for exhaust gas. Among the electrodes, the electrode where an oxidative reaction occurs is an anode and the electrode where a reduction reaction occurs is a cathode.

The ammonia production method of this embodiment is a method for producing ammonia from nitrogen molecules by donating electrons from a power supply, protons from a proton source disposed in the electrolytic apparatus, and the nitrogen molecules from supply means of a nitrogen gas in the presence of a complex represented by a molybdenum complex or the like and a solid catalyst in the cathode. In this method, as the catalyst for producing ammonia, the complex and the solid catalyst are used in a combined form in the cathode. The catalyst in the form of the combination of the complex and the solid catalyst may be described as a catalyzer in this Description.

As the complex in the ammonia production method of this embodiment, (A) a molybdenum complex having 2,6-bis(dialkylphosphinomethyl) pyridine (where two alkyl groups may be identical or different, and at least one hydrogen atom on a pyridine ring may be substituted with an alkyl group, an alkoxy group, or a halogen atom) as a PNP ligand; (B) a molybdenum complex having N,N-bis(dialkylphosphinomethyl) dihydrobenzimidazolidene (where two alkyl groups may be identical or different, and at least one hydrogen atom on a benzene ring may be substituted with an alkyl group, an alkoxy group, or a halogen atom) as a PCP ligand; (C) a molybdenum complex having bis(dialkylphosphinoethyl) arylphosphine (where two alkyl groups may be identical or different) as a PPP ligand; or (D) a molybdenum complex expressed as trans-Mo(N₂)₂(R⁵R⁶R⁷P)₄ (where R⁵ and R⁶ are aryl groups that may be identical or different, R⁷ is an alkyl group, and two R⁷ groups may be connected with one another to form an alkylene chain) is used.

In the molybdenum complex (A), an example of the alkyl group includes a C₁ to C₁₀ alkyl group, the number of carbon atoms of 1 to 10 is preferred, the number of carbon atoms of 3 to 6 is more preferred, and an isopropyl group, a t-butyl group, and a cyclohexyl group are further preferred. In the molybdenum complex (A), examples of the alkoxy group include a C₁ to C₈ alkoxy group and a benzyloxy group, the number of carbon atoms of 1 to 8 is preferred, and when the alkoxy group is the benzyloxy group, at least one hydrogen atom on the benzene ring of the benzyloxy group may be substituted with a resin. Examples of the halogen atom include a fluorine atom, a chlorine atom, a bromine atom, and an iodine atom.

The molybdenum complex (A) is, for example, a molybdenum complex expressed by Formula (A1), (A2), or (A3):

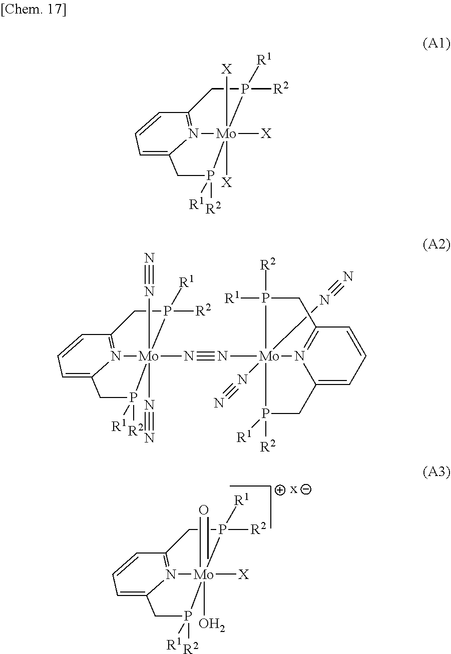

(In the formula, R¹ and R² are alkyl groups that may be identical or different, X is an iodine atom, a bromine atom, or a chlorine atom, and at least one hydrogen atom on a pyridine ring may be substituted with an alkyl group, an alkoxy group, or a halogen atom). The alkyl group, the alkoxy group, and the halogen atom include the ones same as the ones that have been already exemplified. As R¹ and R², for example, a t-butyl group, an isopropyl group, or a cyclohexyl group, which is the bulky alkyl group, is preferred. It is preferable that the hydrogen atom on the pyridine ring is not substituted or that 4-position hydrogen atom is substituted with the C₁ to C₁₀ alkyl group, the C₁ to C₈ alkoxy group, or the benzyloxy group. The more preferable alkoxy group is a benzyloxy group having at least one hydrogen atom on the benzene ring substituted with a resin. Examples of the resin include chloromethyl resins (for example, polymer-bound 5-[4-(chloromethyl)phenyl] pentyl] styrene, polymer-bound 4-(benzyloxy)benzyl chloride, and polymer-bound 4-methoxybenzhydryl chloride), (chloromethyl) polystyrene, Merrifield resin, and JandaJel-Cl (registered trademark). Among them, (chloromethyl) polystyrene, Merrifield resin, and JandaJel-Cl (registered trademark) are preferable.

The molybdenum complex (B) is a molybdenum complex expressed by the following Formula (B1) or (B2):

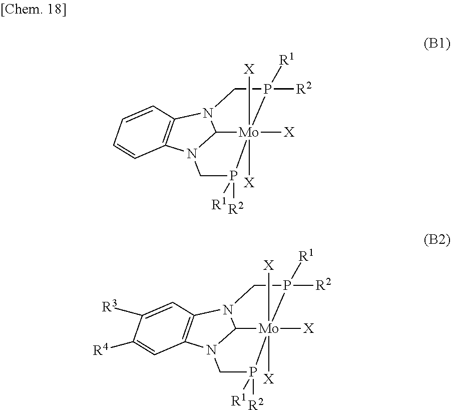

(In the formula, R¹ and R² are the C₁ to C₁₀ alkyl groups that may be identical or different, X is an iodine atom, a bromine atom, or a chlorine atom, and at least one hydrogen atom on a benzene ring of the molybdenum complex (B1) may be substituted with the C₁ to C₁₀ alkyl group, the C₁ to C₈ alkoxy group, or the halogen atom). The C₁ to C₁₀ alkyl group, the C₁ to C₈ alkoxy group, and the halogen atom include the ones same as the ones that have been already exemplified. As R¹ and R², a t-butyl group, an isopropyl group, or a cyclohexyl group, which is the bulky alkyl group, is preferred.

Each of R³ and R⁴ of the molybdenum complex (B2) independently expresses an electron attractive group, R³ and R⁴ may be electron attractive groups, and when R³ is an electron attractive group, R⁴ may be a hydrogen atom. The electron attractive group is also referred to as an electron withdrawing group or an electron-accepting group and represents a substituent that attracts electrons from the bound electron side compared with hydrogen atoms by a mesomeric effect and an inductive effect in the electronic theory, which is a theory that attempts interpretation focusing on changes in an electron density and a binding state of a substance as standardized as possible.

The electron attractive groups include a substituent in which the mesomeric effect is electron-donating but electron attractive contribution of the inductive effect is large and a substituent in which the mesomeric effect and the inductive effect are electron attractive. Examples of the substituent whose mesomeric effect is electron donating, but the electron attractive contribution of the inductive effect is large include fluorine atoms, chlorine atoms, bromine atoms, iodine atoms, —CH₂Cl, or —CH═CHNO₂. Examples of the substituent whose mesomeric effect and inductive effect are electron attractive include a quaternary ammonium group having anions as counterions, a trifluoromethyl group, a perfluoroalkyl group, a trichloromethyl group, a cyano group, a nitro group, a formyl group, a carboxylic acid group, a sulfonic acid group, and a sulfonylamino group. The quaternary ammonium group includes a trialkylammonium group, and examples thereof include a trimethylammonium group, a triethylammonium group, and a tributylammonium group. Examples of the counterions for the nitrogen atoms constituting the quaternary ammonium group include hexafluorophosphate ions, hexachloroantimonate ions, trifluoromethanesulfonate ions, tetrafluoroborate ions, phosphate ions, sulfonate ions, chloride, bromide, iodide, and hydroxide.

R³ and R⁴ are preferably fluorine atoms, chlorine atoms, bromine atoms, iodine atoms, and a trifluoromethyl group, and chlorine atoms and a trifluoromethyl group are more preferred.

The molybdenum complex (C) is, for example, a molybdenum complex expressed by Formula (C1):

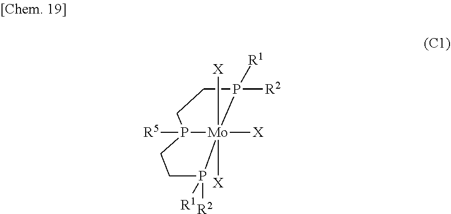

(In the formula, R¹ and R² are the C₁ to C₁₀ alkyl groups that may be identical or different, R⁵ is an Ar₆ aryl group, and X is an iodine atom, a bromine atom, or a chlorine atom). The C₁ to C₁₀ alkyl group includes the ones same as the ones that have been already exemplified. The C₁ to C₁₀ alkyl group and the Ar₆ aryl group include the ones same as the ones that have been already exemplified. As R¹ and R², a t-butyl group, an isopropyl group, or a cyclohexyl group, which is the bulky alkyl group, is preferred. As R⁵, a phenyl group is preferred.

The molybdenum complex (D) is a molybdenum complex expressed by Formula (D1) or (D2):

### [Chem. 20]

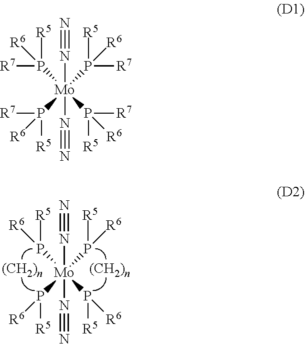

(In the formula, R⁵ and Re are the Arg aryl groups that may be identical or different, R⁷ is the C₁ to C₁₀ alkyl group; and n is 2 or 3). The Ar₆ aryl group and the C₁ to C₁₀ alkyl group include the ones same as the ones that have been already exemplified. In Formula (D1), it is preferable that R⁵ and R⁶ are phenyl groups and R⁷ is a C₁ to C₄ alkyl group. In Formula (D2), it is preferable that R⁵ and R⁶ are phenyl groups and n is 2.

Examples of the solid catalyst in the ammonia production method of this embodiment include a metal catalyst used as a single composition in some cases and obtained by mixing a plurality of metal components as in an alloy catalyst in some cases, and an oxide catalyst used as a metal oxide of a representative element in some cases, used as a transition metal oxide in some cases, or obtained by mixing a plurality of metal oxides in some cases. The metal oxide may be used as a carrier of the solid catalyst.

Examples of the solid catalyst in the ammonia production method of this embodiment include, as a metal catalyst, a metal, such as a platinum catalyst, a gold catalyst, a silver catalyst, a ruthenium catalyst, an iridium catalyst, a rhodium catalyst, a palladium catalyst, an osmium catalyst, a tungsten catalyst, a lead catalyst, an iron catalyst, a chromium catalyst, a cobalt catalyst, a nickel catalyst, a manganese catalyst, a vanadium catalyst, a molybdenum catalyst, a gallium catalyst, and an aluminum catalyst, and alloys thereof, and, as an oxide catalyst, aluminum oxide, zirconium oxide, titanium oxide, vanadium oxide, chromium oxide, manganese oxide, iron oxide, cobalt oxide, nickel oxide, copper oxide, zinc oxide, niobium pentoxide, molybdenum oxide, cerium oxide, samarium oxide, ruthenium oxide, rhodium oxide, silver oxide, tantalum oxide, tungsten oxide, osmium oxide, iridium oxide, indium oxide, platinum oxide, gold oxide, magnesium oxide, silica, silica-alumina, and silica-magnesia.

Among them, a solid catalyst used on the cathode side is defined as a cathode solid catalyst, and the preferred cathode solid catalysts include a platinum catalyst, a gold catalyst, an iridium catalyst, a palladium catalyst, a molybdenum catalyst, zinc oxide, aluminum oxide, molybdenum oxide, cerium oxide, and samarium oxide, and more preferred cathode solid catalysts include a platinum catalyst, a gold catalyst, zinc oxide, aluminum oxide, cerium oxide, and samarium oxide.

A catalyzer on the cathode side, which is a catalyst in combination of the complex and the cathode solid catalyst in the ammonia production method of this embodiment, is defined as a cathode catalyzer. The preferable combinations of the cathode catalyzer include a combination of the molybdenum complex of Formula (A1) and a platinum catalyst, a combination of the molybdenum complex of Formula (A1) and a gold catalyst, a combination of the molybdenum complex of Formula (A1) and a palladium catalyst, a combination of the molybdenum complex of Formula (B2) and a platinum catalyst, a combination of the molybdenum complex of Formula (B2) and a gold catalyst, and a combination of the molybdenum complex of Formula (B2) and a palladium catalyst.

A cathode catalyst layer 103 for producing ammonia of this embodiment includes a catalyst carrier, an electron conductor, an electrolyte, and a gas diffusion layer in addition to the cathode catalyzer, which is the catalyst in combination of the complex and the cathode solid catalyst. In this Description, the cathode catalyst layer 103 including the cathode catalyzer in combination of the complex and the cathode solid catalyst, the catalyst carrier, the electron conductor, the electrolyte, and the gas diffusion layer may be described as a gas diffusion electrode 133 (hereafter also referred to as “GDE”).

The reaction field forming material in the ammonia production method of this embodiment is a material for forming a reaction field for promoting carrying a reaction gas, electrons, and protons to the complex and/or the solid catalyst in the cathode catalyst layer and/or the anode catalyst layer, and examples thereof include a rare earth metal-carbon-based binder and a calcined body.

The rare earth metal-carbon-based binder will be described below. The rare earth metal-carbon-based binder is a complex of rare earth metal ions and the calcined body that can be obtained by performing a reaction of calcining the conventional carbon material having conductivity and an aromatic compound having a phenolic hydroxyl group to obtain a calcined body, and subsequently performing a reaction to obtain the complex of the calcined body and the rare earth metal ions or performing calcination.

In this Description, the one obtained by calcining the mixture of the aromatic compound having the phenolic hydroxyl group and the carbon material having conductivity is defined as a “calcined body.”

In this Description, the complex of the calcined body and the rare earth metal ions in which the rare earth metal ions form a complex with a substituent or a structure possessed by the calcined body is defined as the “rare earth metal-carbon-based binder.”

The aromatic compound having the phenolic hydroxyl group in the calcined body of this embodiment includes a compound in which a monocyclic or condensed polycyclic aromatic compound has one or more phenolic hydroxyl groups.

Among them, the aromatic compound includes monovalent to hexavalent phenols as a monocyclic aromatic compound having one to six phenolic hydroxyl groups.

Examples of the phenols as the monocyclic aromatic compound having one phenolic hydroxyl group include phenol, ethylphenol, p-t-butylphenol, o-cresol, m-cresol, p-cresol, 2,3-xylenol, 2,4-xylenol, 2,5-xylenol, 2,6-xylenol, thymol, mesitol, pseudocumene, 2,6-di-t-butyl-p-cresol, pentamethylphenol, o-hydroxystyrene, m-hydroxystyrene, p-hydroxystyrene, chavicol, o-allylphenol, anol, diethylstilbestrol, p-(methylthio) phenol, o-aminophenol, m-aminophenol, p-aminophenol, 0-(methylamino) phenol, m-(methylamino) phenol, p-(methylamino) phenol, m-(dimethylamino) phenol, o-anilinophenol, m-anilinophenol, p-anilinophenol, 2-amino-p-cresol, 3-amino-o-cresol, 3-amino-p-cresol, 4-amino-o-cresol, 4-amino-p-cresol, 5-amino-o-cresol, 6-amino-m-cresol, 2,4-diaminophenol, or 2,4,6-triaminophenol.

Examples of the phenols as the monocyclic aromatic compound having two phenolic hydroxyl groups include catechol, resorcinol, hydroquinone, 3,4-toluenediol, 2,5-toluenediol, 3,5-toluenediol, 2,4-toluenediol, urushiol, p-xylene-2,6-diol, m-xylene-4,6-diol, p-xylene-2,5-diol, or 2-isopropyl-5-methylhydroquinone.

Examples of the phenols as the monocyclic aromatic compound having three phenolic hydroxyl groups include pyrogallol, 1,2,4-benzenetriol, phloroglucinol, 2-methylphloroglucinol, m-xylene-2,4,6-triol, or 2,4,6-trimethylphloroglucinol.

Examples of the phenols as the monocyclic aromatic compound having four phenolic hydroxyl groups include 1,2,3,5-benzenetetraol or 1,2,4,5-benzenetetraol.

Examples of the phenols as the monocyclic aromatic compound having six phenolic hydroxyl groups include hexahydroxybenzene.

As the monocyclic aromatic compound having the phenolic hydroxyl group, three to six phenols having three to six phenolic hydroxyl groups are more preferred, phenols in which the monocyclic aromatic compound has three phenolic hydroxyl groups are further preferred, and phloroglucinol expressed by the following Formula (I) is particularly preferred.

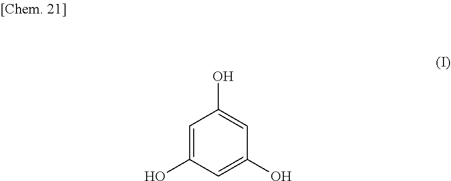

Examples of the condensed polycyclic aromatic compound include naphthalene, azulene, heptalene, biphenylene, acenaphthylene, fluorene, phenalene, phenanthrene, anthracene, aceanthrylene, triphenylene, pyrene, chrysene, tetracene, perylene, pentacene, picene, or coronene, and naphthalene, anthracene, and triphenylene are preferred.

Examples of the condensed polycyclic aromatic compound having the phenolic hydroxyl group include 1,2-dihydroxynaphthalene, 1,3-dihydroxynaphthalene, 1,4-dihydroxynaphthalene, 1,5-dihydroxynaphthalene, 1,6-dihydroxynaphthalene, 2,3-dihydroxynaphthalene, 2,4-dihydroxynaphthalene, 2,5-dihydroxynaphthalene, 2,6-dihydroxynaphthalene, 1,3,8-trihydroxynaphthalene, 9,10-anthracene, or 2,3,6,7,10,11-hexahydroxytriphenylene, preferably 2,6-dihydroxynaphthalene, 1,3,8-trihydroxynaphthalene, 9,10-anthracene, and 2,3,6,7,10,11-hexahydroxytriphenylene, and more preferably 2,3,6,7,10,11-hexahydroxytriphenylene expressed by the following Formula (II).

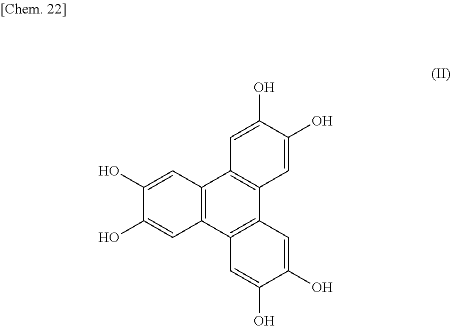 [SMILES: Oc1cc2c3cc(O)c(O)cc3c3cc(O)c(O)cc3c2cc1O]

One kind of the aromatic compound having the phenolic hydroxyl group may be used alone, or two or more kinds of them may be used in combination.

Examples of the carbon material having conductivity of this embodiment (hereafter also referred to as the “carbon material”) include a carbon black and a carbon nanotube. Examples of the carbon black include Ketjenblack, Ketjenblack EC, channel black, oil furnace black, vulcan, furnace black, thermal black, acetylene black, lamp black, graphitized black, and oxide black. Since the conductivity is satisfactory, acetylene black, Ketjenblack, and Ketjenblack EC are preferred, and Ketjenblack and Ketjenblack EC are more preferred. One kind of the carbon black may be used alone, or two or more kinds of them may be used in combination. The carbon black may be surface-treated.

Examples of the carbon nanotube include a single-walled nanotube and a multiwalled carbon nanotube obtained by gas-phase growth method, catalyst gas-phase growth method, catalytic chemical gas-phase growth method, chemical gas-phase growth method, super-growth method, catalytic carbon vapor deposition method, arc discharge method, and laser vaporization method, and they can take any form, such as forms of a needle shape, a coil shape, and a tube shape. The tube of the carbon nanotube has a shape formed by tubularly winding one surface of graphite of a carbon hexagonal mesh surface. Examples thereof include a multi-walled carbon nanotube wound to be three or more layers, a single-walled carbon nanotube (SWNT) formed by winding the first surface of graphite to be one layer, a double-walled carbon nanotube (DWNT) wound to be two layers, and a vapor-grown carbon fiber (VGCF, registered trademark produced by Showadenkosya Co., Ltd.). Specifically, examples thereof include the TC series, such as TC-2010, TC-2020, TC-3210L, and TC-1210LN (produced by TODA KOGYO CORP.), super growth method CNT (produced by National Research and Development Corporation New Energy and Industrial Technology Development Organization), eDIPS-CNT (produced by National Research and Development Corporation New Energy and Industrial Technology Development Organization), the SWNT series (produced by Meijo Nano Carbon Co., Ltd.: product name), the VGCF (registered trademark) series, such as VGCF, VGCF-H, and VGCF-X (produced by Showadenkosya Co., Ltd.: registered trademark), the FloTube series (produced by Cnano Technology Ltd.: product name), AMC (produced by Ube Kosan Co., Ltd.: product name), the NANOCYL NC7000 series (produced by Nanocyl S.A.: product name), Baytubes (produced by Bayer: product name), GRAPHISTRENGTH (produced by Arkema: product name), MWNT7 (produced by Hodogaya Chemical Co., Ltd.: product name), and Hypeprion CNT (produced by Hypeprion Catalysis International: product name). The TC series, such as TC-2010, TC-2020, TC-3210L, and TC-1210LN, and the VGCF (registered trademark) series, such as VGCF, VGCF-H, and VGCF-X, are preferred.

One kind of the carbon nanotube may be used alone, or two or more kinds of them may be used in combination. The carbon nanotube may be surface-treated. Further, the carbon black and the carbon nanotube may be used in combination.

The carbon material having conductivity is preferably at least one kind selected from the group consisting of Ketjenblack, Ketjenblack EC, and a carbon nanotube.

The carbon material having conductivity preferably has at least one kind of a substituent selected from the group consisting of a hydroxyl group, a carboxyl group, a carbonyl group, a formyl group, a sulfonic acid group, an oxysulfonic acid group, a carboxylic anhydride structure, a chromene structure, a lactone structure, an ester structure, and an ether structure, more preferably has at least one kind of a substituent selected from the group consisting of a hydroxyl group, a carboxyl group, a formyl group, a carboxylic anhydride structure, a lactone structure, an ester structure, and an ether structure, and further more preferably has at least one kind of a substituent selected from the group consisting of a hydroxyl group, a lactone structure, and an ester structure.

The production method of the calcined body of this embodiment will be described. The calcined body is obtained by calcining the mixture of the aromatic compound having the phenolic hydroxyl group and the carbon material having conductivity.

The calcining temperature only needs to be a temperature at which the aromatic compound having the phenolic hydroxyl group can be carbonized, is preferably from 150 to 1000° C., more preferably from 200 to 600° C., and further more preferably from 250 to 450° C. The calcination is performed at the calcining temperature preferably for 1 to 10 hours, and more preferably for 1 to 5 hours. The calcination is preferably performed under air or an inert gas. Examples of the inert gas include nitrogen and argon.

Metal species of the rare earth metal ions in the rare earth metal-carbon-based binder as the reaction field forming material of this embodiment include scandium, yttrium, lanthanum, cerium, praseodymium, neodymium, promethium, samarium, europium, gadolinium, terbium, dysprosium, holmium, erbium, thulium, ytterbium, or lutetium, are preferably scandium, yttrium, lanthanum, cerium, praseodymium, neodymium, samarium, europium, gadolinium, and ytterbium, and are more preferably scandium, yttrium, lanthanum, cerium, samarium, europium, and ytterbium.

In the complex of the calcined body and the rare earth metal ions, the substituent of the calcined body and the rare earth metal ions form a complex.

The complex structures of the substituent of the calcined body and the rare earth metal ions include: a complex structure of a substituent derived from a surface of a carbon material and a deficient portion of a carbon and the rare earth metal ions; and a complex structure of a hydroxyl group derived from the aromatic compound having the phenolic hydroxyl group and the rare earth metal ions. They may have either one of the complex structures or both complex structures.

The complex structure of the substituent derived from the surface of the carbon material and the deficient portion of the carbon and the rare earth metal ions includes the binding of formally deprotonated monovalent anions from at least one kind of a substituent selected from the group consisting of a hydroxyl group, a carboxyl group, a carbonyl group, a formyl group, a sulfonic acid group, an oxysulfonic acid group, a carboxylic anhydride structure, a chromene structure, a lactone structure, an ester structure, and an ether structure derived from the carbon material with the rare earth metal ions. Preferably, the rare earth metal ions form the complex structure with the substituent on the surface of the carbon material and the deficient portion of the carbon via —O—. More preferably, due to the increased stability, the rare earth metal ions form one or more annular structures, namely, a chelate ring, with the surface of the carbon material via —O—.

The complex structure of the hydroxyl group derived from the aromatic compound having the phenolic hydroxyl group with the rare earth metal ions includes a complex structure of a partial structure expressed by the following Formula (a) formed from the aromatic compound having the phenolic hydroxyl group by calcining with the rare earth metal ions, for example, a partial structure expressed by Formula (b).

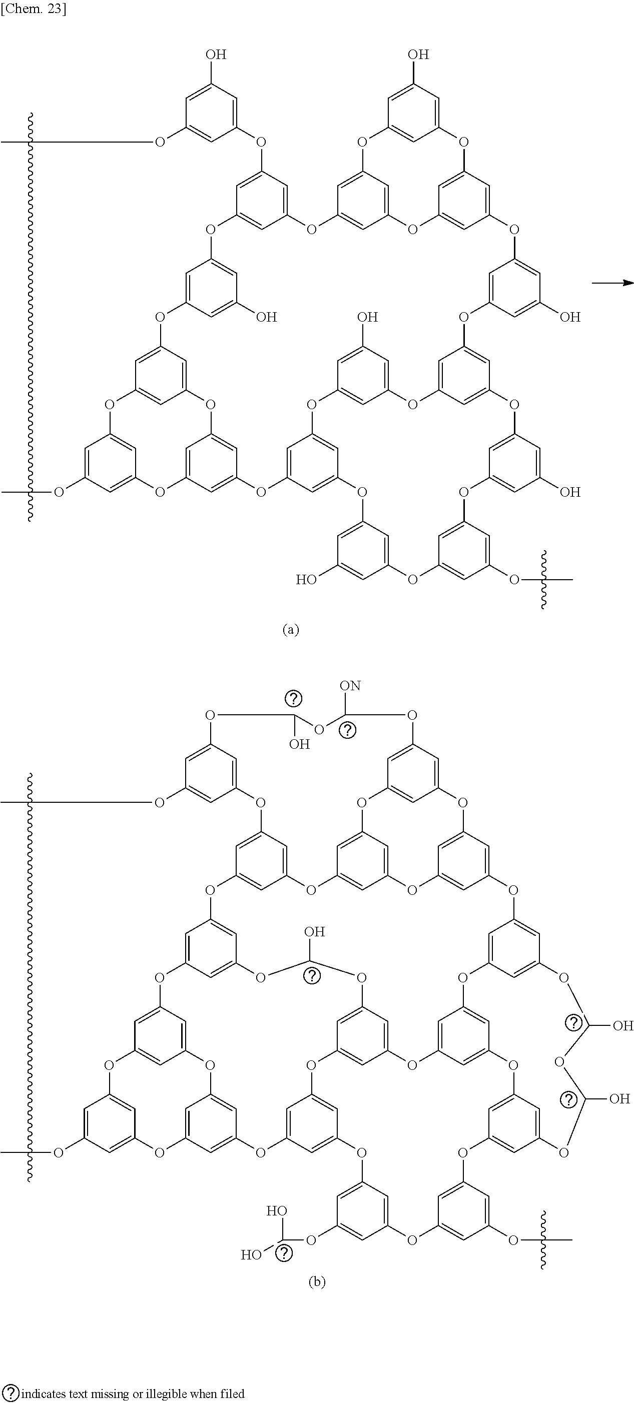

### <Production Method of Rare Earth Metal-Carbon-Based Binder A>

The rare earth metal-carbon-based binder, in which the rare earth metal ions form the complex structure with the substituent of the calcined body, can be produced by Step 1A. From the aspect of durability, Step 2A is preferably performed after Step 1A.

### [Step 1A]

In Step 1A, the calcined body of the present invention and a rare earth metal compound are reacted to obtain the rare earth metal-carbon-based binder as the complex of the calcined body and the rare earth metal ions in which the complex is formed between the rare earth metal ions and the substituent of the calcined body of the present invention.

In Step 1A, the reaction between the calcined body and the rare earth metal compound is done in a solvent.

The substituent of the calcined body used in the reaction of Step 1A is preferably at least one kind selected from the group consisting of a hydroxyl group, a carboxyl group, a carbonyl group, a formyl group, a sulfonic acid group, an oxysulfonic acid group, a carboxylic anhydride structure, a chromene structure, a lactone structure, an ester structure, and an ether structure, more preferably has at least one kind of a substituent selected from the group consisting of a hydroxyl group, a carboxyl group, a formyl group, a carboxylic anhydride structure, a lactone structure, an ester structure, and an ether structure, and is further preferably at least one kind selected from the group consisting of a hydroxyl group, a lactone structure, an ester structure, and an ether structure.

Examples of the rare earth metal compound used in Step 1A include a rare earth metal alkoxide compound and a rare earth metal acetylacetonato compound, in addition to:
CeBr₃, CeCl₃·7H₂O, CeF₃, CeF₄, CeI₃,
DyBr₃, DyBr₃·xH₂O, DyCl₃, DyCl₃·6H₂O, DyF₃, DyI₃,
ErBr₃·xH₂O, ErCl₃, ErCl₃·6H₂O, ErF₃, ErI₃,
EuBr₃·xH₂O, EuCl₂, EuCl₃, EuCl₃·6H₂O, EuF₃, EuI₂,
GdBr₃, GdCl₃, GdCl₃·6H₂O, GdCl₃·xH₂O, GdF₃, GdI₃,
HoBr₃, HoBr₃·xH₂O, HoCl₃, HoCl₃·6H₂O, HoF₃,
LaBr₃·xH₂O, LaCl₃·7H₂O, LaCl₃·xH₂O, LaF₃, LaI₃,
LuBr₃, LuCl₃, LuCl₃·6H₂O, LuF₃, LuI₃,
NdBr₃, NdCl₃, NdCl₃·6H₂O, NdF₃, NdI₂, NdI₃,
PrBr₃, PrBr₃·xH₂O, PrCl₃,
SmBr₃, SmCl₃, SmCl₃·6H₂O, SmI₂, SmI₃,
ScBr₃, ScCl₃, ScCl₃·6H₂O, ScF₃, ScI₃,
TbBr₃, TbCl₃, TbCl₃·6H₂O, TbF₃, TbI₃,
TmBr₃, TmCl₃, TmCl₃·6H₂O, TmF₃,
YbBr₃, YbBr₃·xH₂O, YbCl₃, YbCl₃·6H₂O, YbF₃, Ybl₂,
YCl₃, YCl₃·6H₂O, YF₃, YI₃,
Ce(NH₄)₂(NO₃)₆, Ce(NO₃)₃·6H₂O, Dy(NH₄)₂(NO₃)₆, Er(NO₃)₃·5H₂O, Er(NO₃)₃·xH₂O,
Gd(NO₃)₃·6H₂O, Ho(NO₃)₃·5H₂O, La(NO₃)₃·6H₂O, La(NO₃)₃·xH₂O, Lu(NO₃)₃·xH₂O,
Nd(NO₃)₃·6H₂O, Pr(NO₃)₃·6H₂O, Sm(NO₃)₃·6H₂O, Tb(NO₃)₃·5H₂O, Tb(NO₃)₃·6H₂O,
Yb(NO₃)₃·5H₂O,
Ce(CH₃CO₂)₃·xH₂O, Eu(CH₃CO₂)₃·xH₂O,
Gd(CH₃CO₂)₃·xH₂O, La(CH₃CO₂)₃·xH₂O,
Tb(CH₃CO₂)₃·xH₂O, Yb(C₂H₃O₂)₃·4H₂O
CeO₂, Dy₂O₃, Er₂O₃, Eu₂O₃, Gd₂O₃, Ho₂O₃, La₂O₃, Lu₂O₃, Nd₂O₃,
Pr₂O₃, Pr₆O₁₁, Sm₂O₃, Sc₂O₃, Tb₂O₃, Tb₄O₇, Tm₂O₃, Yb₂O₃, Y₂O₃, and
AlCeO₃, (CeO₂) (ZrO₂). One kind of them may be used alone, or two or more kinds of them may be used in combination.

A specific example of the rare earth metal alkoxide compound includes rare earth metal triisopropoxide. Specific examples of the rare earth metal triisopropoxide include scandium triisopropoxide, yttrium triisopropoxide, lanthanum triisopropoxide, cerium triisopropoxide, praseodymium triisopropoxide, neodymium triisopropoxide, promethium triisopropoxide, samarium triisopropoxide, europium triisopropoxide, gadolinium triisopropoxide, terbium triisopropoxide, dysprosium triisopropoxide, holmium triisopropoxide, erbium triisopropoxide, thulium triisopropoxide, ytterbium triisopropoxide, and lutetium triisopropoxide. Specific examples of the rare earth metal acetylacetonato compound include tris(acetylacetonato) scandium (III), tris(acetylacetonato) yttrium (III), tris(acetylacetonato) lanthanum (III), tris(acetylacetonato) cerium (III), tris(acetylacetonato) neodymium (III), tris(acetylacetonato) promethium (III), tris(acetylacetonato) samarium (III), tris(acetylacetonato) europium (III), tris(acetylacetonato) gadolinium (III), tris(acetylacetonato) terbium (III), tris(acetylacetonato) dysprosium (III), tris(acetylacetonato) holmium (III), tris(acetylacetonato) erbium (III), tris(acetylacetonato) thulium (III), tris(acetylacetonato) ytterbium (III), and tris(acetylacetonato) lutetium (III), and they may take a form of a hydrate.

The rare earth metal compound used in Step 1A is preferably at least one kind selected from the group consisting of:
CeBr₃, CeCl₃·7H₂O, CeF₃, CeF₄, CeI₃,
EuBr₃·xH₂O, EuCl₂, EuCl₃, EuCl₃·6H₂O, EuF₃, EuI₂,
NdBr₃, NdCl₃, NdCl₃·6H₂O, NdF₃, NdI₂, NdI₃,
SmBr₃, SmCl₃, SmCl₃·6H₂O, SmI₂, SmI₃,
Ce(NH₄)₂(NO₃)₆, Ce(NO₃)₃·6H₂O,
Nd(NO₃)₃·6H₂O,
Ce(CH₃CO₂)₃·xH₂O, Ce(C₅H₇O₂)₃·xH₂O, Eu(CH₃CO₂)₃·xH₂O,
CeO₂, Eu₂O₃, Nd₂O₃,
Sm₂O₃, Sc₂O₃, (CeO₂) (ZrO₂), and samarium triisopropoxide. At least one kind selected from the group consisting of CeBr₃, CeCl₃·7H₂O, CeF₃, CeF₄, CeI₃, EuI₂, NdI₂, NdI₃, SmBr₃, SmCl₃, SmCl₃·6H₂O, SmI₂, SmI₃, Ce(NH₄)₂(NO₃)₆, Ce(NO₃)₃·6H₂O, Ce(CH₃CO₂)₃·xH₂O, Ce(C₅H₇O₂)₃·xH₂O, Sm₂O₃, and samarium triisopropoxide is more preferred.

Step 1 A can also be performed in the presence of, for example, sodium hydride, lithium hydride, sodium hydroxide, 1,8-diazabicyclo-5,4,0-undeca-7-ene (DBU), trimethylamine, triethylamine, tripropylamine, N-ethylmethylbutylamine, tributylamine, N,N-dimethylbenzylamine, N,N-diethylbenzylamine, and tribenzylamine. Among them, sodium hydride and lithium hydride are preferred.

The solvent used in Step 1A only needs to be a non-aqueous solvent as long as it can disperse the calcined body and can dissolve or disperse the rare earth metal compound. Examples thereof include cyclohexane, benzene, toluene, nitrobenzene, carbon tetrachloride, diethyl ether, tetrahydrofuran, isoxazole, 1,4-dioxane, cyclopentyl methyl ether, acetone, acetonitrile, nitromethane, dimethyl sulfoxide, N,N-dimethylformamide, sulfolane, 1,3-propane sultone, and 1,4-butane sultone. 1,3-Propane sultone is the subject of the reaction, but it can also serve as a solvent. Toluene, tetrahydrofuran, dimethyl sulfoxide, N,N-dimethylformamide, and 1,3-propane sultone are preferred, and tetrahydrofuran is more preferred.

The reaction temperature of Step 1A is preferably from −10 to 200° C., more preferably from 10 to 160° C., and further preferably from 15 to 140° C.

The reaction time of Step 1A is preferably from 1 to 500 hours, more preferably from 2 to 300 hours, and further preferably from 5 to 150 hours.

### [Step 2A]

In Step 2A, the rare earth metal-carbon-based binder as the complex of the calcined body and the rare earth metal obtained in Step 1A is washed with acid and water. Since the substituent and impurities that causing a reaction have been eliminated from the complex that has undergone Step 2A by cleaning prior to use for a fuel cell device, damage of the fuel cell device by a decomposition product can be reduced as much as possible, and therefore the fuel cell device is excellent in durability.

As the acid used in Step 2A, for example, inorganic acid, such as sulfuric acid, hydrochloric acid, nitric acid, sulfurous acid, nitrous acid, and phosphoric acid, and organic acid, such as acetic acid, lactic acid, oxalic acid, citric acid, and formic acid, can be used, and sulfuric acid in which impurities are less likely to remain is preferred from the aspect of the fuel cell device.

### <Production Method of Rare Earth Metal-Carbon-Based Binder B>

The rare earth metal-carbon-based binder in which the rare earth metal ions form the complex structure with the substituent of the calcined body can be produced by Step 1B, and if required, Step 2B may be performed after Step 1B.

### [Step 1B]

In Step 1B, the mixture of the calcined body of the present invention and the rare earth metal compound is calcined to obtain the complex of the calcined body and the rare earth metal ions in which the complex structure of the rare earth metal ions and the substituent of the calcined body is formed.

The substituent of the calcined body used in the reaction of Step 1B is preferably at least one kind selected from the group consisting of a hydroxyl group, a carboxyl group, a carbonyl group, a formyl group, a sulfonic acid group, an oxysulfonic acid group, a carboxylic anhydride structure, a chromene structure, a lactone structure, an ester structure, and an ether structure, more preferably at least has one kind of a substituent selected from the group consisting of a hydroxyl group, a carboxyl group, a formyl group, a carboxylic anhydride structure, a lactone structure, and an ester structure, and is further preferably at least one kind selected from the group consisting of a hydroxyl group, a lactone structure, an ester structure, and an ether structure.

The rare earth metal compound used in Step 1B includes the compounds same as the compounds described in Step 1A.

As the rare earth metal compound used in Step 1B, at least one kind selected from the group consisting of:
Ce(CH₃CO₂)₃·xH₂O, Ce(C₅H₇O₂)₃·xH₂O, Eu(CH₃CO₂)₃·xH₂O, Gd(CH₃CO₂)₃·xH₂O,
Gd(C₅H₇O₂)₃·xH₂O, La(CH₃CO₂)₃·xH₂O, La(C₅H₇O₂)₃·xH₂O,
Tb(CH₃CO₂)₃·xH₂O, Yb(C₂H₃O₂)₃·4H₂O, cerium triisopropoxide, samarium triisopropoxide, tris(acetylacetonato) cerium (III), and tris(acetylacetonato) samarium (III) is preferred, and at least one kind selected from the group consisting of Ce(CH₃CO₂)₃·xH₂O, Ce(C₅H₇O₂)₃·xH₂O, samarium triisopropoxide, tris(acetylacetonato) cerium (III), and tris(acetylacetonato) samarium (III) is more preferred.

The calcining temperature of Step 1B is preferably from 100 to 1000° C., more preferably from 150 to 600° C., and further preferably from 200 to 500° C.

The calcining time of Step 1B is preferably from 1 to 500 hours, more preferably from 2 to 300 hours, and further preferably from 5 to 150 hours.

The atmosphere of calcination in Step 1B can be performed under an atmospheric air and an inert gas, the atmospheric air includes air, and the inert gas includes nitrogen, argon, and the like. The atmosphere of calcination is preferably under the inert gas and nitrogen is preferred as the inert gas.

### [Step 2B]

Step 2B is similar to [Step 2A].

The catalyst carrier in the cathode catalyst layer 103 of this embodiment may be responsible for electron conduction, and is not particularly limited as long as it supports the catalyst of this embodiment. Examples of the catalyst carrier include a carbon black, a carbon material, a metal mesh, a metal foam, a metal oxide, a composite oxide, a polymer electrolyte, and ionic liquid. In addition, when the catalyst carrier is used at an electrode, it is possible to not only be responsible for supporting a catalyst but also involving in a reaction occurring at the electrode as a catalyst or a cocatalyst.

Examples of the carbon black include channel black, furness black, thermal black, acetylene black, Ketjenblack, and Ketjenblack EC. Examples of the carbon material include activated carbon obtained by carbonizing and activating a material containing various kinds of carbon atoms, coke, natural graphite, artificial graphite, and graphitized carbon. The metal mesh includes a metal mesh, such as nickel or titanium. Examples of the metal foam include metal foam, such as aluminum, magnesium, titanium, zinc, iron, tin, lead, or alloys containing thereof. Examples of the metal oxide include aluminum oxide, zirconium oxide, titanium oxide, vanadium oxide, chromium oxide, manganese oxide, iron oxide, cobalt oxide, nickel oxide, copper oxide, zinc oxide, niobium pentoxide, molybdenum oxide, ruthenium oxide, rhodium oxide, silver oxide, tantalum oxide, tungsten oxide, osmium oxide, iridium oxide, indium oxide, platinum oxide, gold oxide, magnesium oxide, or silica. Examples of the composite oxide include silica-alumina and silica-magnesia. Examples of the polymer electrolyte include a fluorine-based polymer electrolyte or a hydrocarbon-based polymer electrolyte. Examples of the fluorine-based polymer electrolyte include fluorine-based sulfonic acid polymers, such as Nafion (registered trademark) by DuPont, Aquivion (registered trademark) by Solvay S.A., FLEMION (registered trademark) by AGC Inc., and Aciplex (registered trademark) by Asahi Kasei Corporation, hydrocarbon-based sulfonic acid polymers, and partially fluorinated hydrocarbon-based sulfonic acid polymers. Examples of the hydrocarbon-based polymer electrolyte include sulphonated polyetherketone, sulphonated polyether sulfone, sulphonated polyether ether sulfone, sulphonated polysulfide, and sulphonated polyphenylene. Examples of the ionic liquid include imidazolium salt, pyridinium salt, ammonium salt, phosphonium salt, pyrrolidinium salt, piperidinium salt, or sulfonium salt.

The ionic liquid of this embodiment will be described below.

A specific example of the imidazolium salt includes the one expressed by Formula (1):

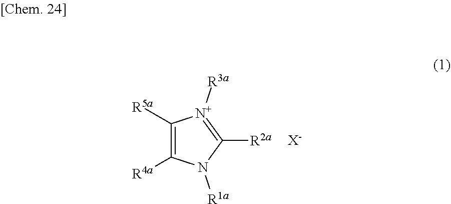

In Formula (1), R^{1a} to R^{5a} may be identical or different, and each of them includes, for example, a hydrogen atom, a C₁ to C₁₀ alkyl group, an allyl group, or a vinyl group. Further, examples of X⁻ in Formula (1) include chlorine ions, bromine ions, iodine ions, tetrafluoroborate, trifluoro (trifluoromethyl) borate, dimethylphosphate ions, diethylphosphate ions, hexafluorophosphate, tris(pentafluoroethyl) trifluorophosphate, trifluoroacetate, methylsulfate, trifluoromethanesulfonate, and bis(trifluoromethanesulfonyl) imide.

Specific examples of Formula (1) include imidazolium ions, such as
1-allyl-3-methylimidazolium ions, 3-ethyl-1-vinylimidazolium ions,
1-methylimidazolium ions, 1-ethylimidazolium ions, 1-n-propylimidazolium ions,
1,3-dimethyl imidazolium ions, 1,2,3-trimethylimidazolium ions,
1-ethyl-3-methylimidazolium ions, 1-ethyl-2,3-dimethylimidazolium ions,
1,2,3,4-tetramethylimidazolium ions, 1,3-diethylimidazolium ions,
1-methyl-3-n-propylimidazolium ions, 1-ethyl-3-methylimidazolium ions,
2-ethyl-1,3-dimethylimidazolium ions, 1-ethyl-2,3-dimethylimidazolium ions,
1,3-dimethyl-n-propylimidazolium ions, 1,3,4-trimethylimidazolium ions,
2-ethyl-1,3,4-trimethylimidazolium ions, 1,2-dimethyl-3-propylimidazolium ions,
1-butyl-2,3-dimethylimidazolium ions, 1-butyl-3-methylimidazolium ions,
1-hexyl-3-methylimidazolium ions, 1-methyl-3-n-octylimidazolium ions, and salt with X⁻ in Formula (1).

A specific example of the pyridinium salt includes the one expressed by Formula (2):

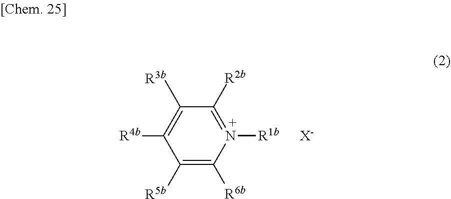

In Formula (2), R¹⁵ to R⁶b may be identical or different, and each of them includes a hydrogen atom, a hydroxymethyl group, or an C₁ to C₆ alkyl group. Additionally, X in Formula (2) includes the one same as Formula (1).

Specific examples of Formula (2) include pyridinium ions, such as
1-butyl-3-methylpyridinium ions, 1-butyl-4-methylpyridinium ions, 1-butyl-pyridinium ions, 1-ethyl-3-methylpyridinium ions, 1-ethylpyridinium ions, and
1-ethyl-3-(hydroxymethyl)pyridinium ions, and salt with X in Formula (1).

A specific example of the ammonium salt includes the one expressed by Formula (3):

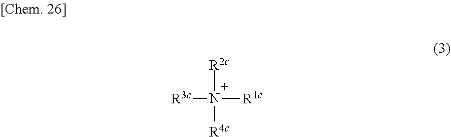

In Formula (3), R^{1c} to R^{4c} may be identical or different, and each of them includes a hydrogen atom, a methoxyethyl group, a phenylethyl group, a methoxypropyl group, a cyclohexyl group, or a C₁ to C₈ alkyl group. Additionally, X in Formula (3) includes the one same as Formula (1).

Specific examples of Formula (3) include ammonium ions, such as triethylpentylammonium ions, diethyl(methyl) propylammonium ions, methyltri-n-octylammonium ions, trimethylpropylammonium ions, cyclohexyltrimethylammonium ions, diethyl(2-methoxyethyl)-methylammonium ions, ethyl(2-methoxyethyl)-dimethylammonium ions, ethyl(3-methoxypropyl)dimethyl-ammonium ions, and ethyl(dimethyl) (2-phenylethyl)-ammonium ions, and salt with X in Formula (1).

A specific example of the phosphonium salt includes the one expressed by Formula (4):

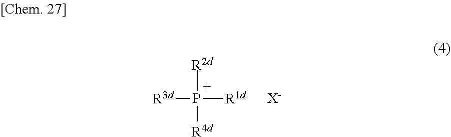

In Formula (4), R^{1d} to R^{4d} may be identical or different, and each of them includes a hydrogen atom, a methoxyethyl group, or a C₁ to C₁₀ alkyl group. Additionally, X in Formula (3) includes the one same as Formula (1).

Specific examples of Formula (4) include phosphonium ions, such as tributylmethylphosphonium ions, tetrabutylphosphonium ions, trihexyl(tetradecyl) phosphonium ions, trihexyl(ethyl) phosphonium ions, and tributyl(2-methoxyethyl)-phosphonium ions, and salt with X in Formula (1).

A specific example of the pyrrolidinium salt includes the one expressed by Formula (5):

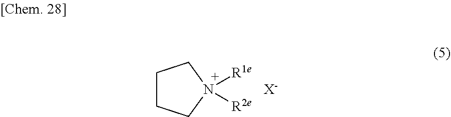

In Formula (5), R^{1e} to R^{2e} may be identical or different, and each of them includes a hydrogen atom, an allyl group, a methoxyethyl group, or a C₁ to C₈ alkyl group. Additionally, X⁻ in Formula (5) includes the one same as Formula (1).

Specific examples of Formula (5) include pyrrolidinium ions, such as 1-allyl-1-methylpyrrolidinium ions, 1-(2-methoxyethyl)-1-methylpyrrolidinium ions, 1-butyl-1-methylpyrrolidinium ions, 1-methyl-1-propylpyrrolidinium ions, 1-octyl-1-methylpyrrolidinium ions, and 1-hexyl-1-methylpyrrolidinium ions, and salt with X⁻ in Formula (1).

A specific example of the piperidinium salt includes the one expressed by Formula (6):

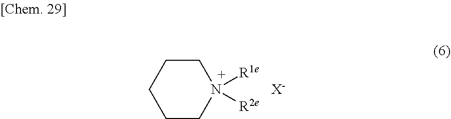

In Formula (6), R^{1f} to R^{2f} may be identical or different, and each of them includes a hydrogen atom or an C₁ to C₆ alkyl group. Additionally, X⁻ in Formula (6) includes the one same as Formula (1).

Specific examples of Formula (6) include piperidinium ions, such as 1-butyl-1-methylpiperidinium ions and 1-methyl-1-propylpiperidinium ions, and salt with X⁻ in Formula (1).

A specific example of the sulfonium salt includes the one expressed by Formula (7):

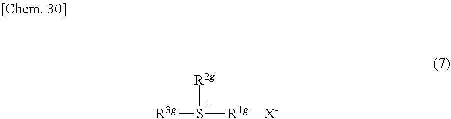

In Formula (7), R¹⁸ to R³⁸ may be identical or different, and each of them includes a hydrogen atom or a C₁ to C₄ alkyl group. Additionally, X in Formula (3) includes the one same as Formula (1).

Specific examples of Formula (7) include sulfonium ions, such as triethylsulfonium ions and trisulfonium ions, and salt with X in Formula (1).

More specifically, the ionic liquids include 1-allyl-3-methylimidazolium chloride, 1-butyl-3-methylimidazolium bromide, 1-butyl-3-methylimidazolium tetrafluoroborate, 1-butyl-3-methylimidazolium hexafluorophosphate,
1-butyl-3-methylimidazolium trifluoromethanesulfonate, 1-butyl-3-methylimidazolium bis(trifluoromethanesulfonyl) imide, 1-butyl-3-methylimidazolium iodide,
1-butyl-3-methylimidazolium tris(pentafluoroethyl) trifluorotrifluoro phosphate,
1-butyl-3-methylimidazolium trifluoro (trifluoromethyl) borate,
1-butyl-2,3-dimethylimidazolium trifluoromethanesulfonate,
1-butyl-3-methylimidazolium trifluoroacetate, tyl-2,3-dimethylimidazolium trifluoromethanesulfonate, 1-butyl-3-methylimidazolium methylsulfate,
1,3-dimethylimidazolium dimethylphosphate, 2,3-dimethyl-1-propylimidazolium bis(trifluoromethanesulfonyl) imide, 1-decyl-3-methylimidazolium bis(trifluoromethanesulfonyl) imide, 1,3-dimethylimidazolium methylsulfate,
1-decyl-3-methylimidazolium bromide, 1-decyl-3-methylimidazolium chloride,
1-decyl-3-methylimidazolium tetrafluoroborate, 1-ethyl-3-methylimidazolium trifluoromethanesulfonate, 1-ethyl-3-methylimidazolium tetrafluoroborate,
1-ethyl-3-methylimidazolium bis(trifluoromethanesulfonyl) imide,
1-ethyl-2,3-dimethylimidazolium bis(trifluoromethanesulfonyl) imide,
1-ethyl-3-methylimidazolium methanesulfonate, 1-ethyl-3-methylimidazolium trifluoro (trifluoromethyl) borate, 3-ethyl-1-vinylimidazolium bis(trifluoromethanesulfonyl) imide, 1-ethyl-3-methyl imidazolium trifluoroacetate,
1-ethyl-3-methylimidazolium methylsulfate, 1-ethyl-3-methylimidazolium diethyl phosphate, 1-hexyl-3-methylimidazolium chloride, 1-hexyl-3-methylimidazolium hexafluorophosphate, 1-hexyl-3-methylimidazolium tetrafluoroborate,
1-hexyl-3-methylimidazolium trifluoromethanesulfonate, 1-hexyl-3-methylimidazolium bromide, 1-(2-hydroxyethyl)-3-methylimidazolium chloride,
1-hexyl-3-methylimidazolium bis(trifluoromethanesulfonyl) imide,
1-(2-hydroxyethyl)-3-methylimidazolium tetrafluoroborate,
1-hexyl-3-methylimidazolium iodide, 1-methyl-3-propylimidazolium iodide,
1-methyl-3-n-octylimidazolium bromide, 1-methyl-3-n-octylimidazolium chloride,
1-methyl-3-n-octylimidazolium hexafluorophosphate, 1-methyl-3-n-octylimidazolium trifluoromethanesulfonate, 1-methyl-3-n-octylimidazolium tetrafluoroborate,
1-methyl-3-propylimidazolium bromide, 1-methyl-3-propylimidazolium tetrafluoroborate, 1-methyl-3-pentylimidazolium bromide,
1-methyl-3-n-octylimidazolium bis(trifluoromethanesulfonyl) imide,
1 methyl-3-propylimidazolium bis(trifluoromethanesulfonyl) imide, 1-butylpyridinium tetrafluoroborate, 1-butyl-4-methylpyridinium tetrafluoroborate, 1-butylpyridinium bis(trifluoromethanesulfonyl) imide, 1-butyl-4-methylpyridinium bis(trifluoromethanesulfonyl) imide, 1-ethyl-3-methylpyridinium ethyl sulfate,
1-ethyl-3-(hydroxymethyl)pyridinium ethyl sulfate, 1-ethyl-3-methylpyridinium bis(trifluoromethanesulfonyl) imide, triethylpentylammonium bis(trifluoromethanesulfonyl) imide, diethyl(methyl) propylammonium bis(fluorosulfonyl) imide, diethyl(2-methoxyethyl)methylammonium bis(fluorosulfonyl) imide, ethyl(2-methoxyethyl)dimethylammonium bis(fluorosulfonyl) imide, ethyl(2-methoxyethyl)dimethylammonium bis(trifluoromethanesulfonyl) imide, ethyl(3-methoxypropyl)dimethylammonium bis(trifluoromethanesulfonyl) imide, ethyl(dimethyl) (2-phenylethyl) ammonium bis(trifluoromethanesulfonyl) imide, methyltri-n-octylammonium bis(trifluoromethanesulfonyl) imide, tributylmethylammonium bis(trifluoromethanesulfonyl) imide, trimethylpropylammonium bis(trifluoromethanesulfonyl) imide, tributylmethylphosphonium bis(trifluoromethanesulfonyl) imide, tributylmethylphosphonium bis(trifluoromethanesulfonyl) imide, tributylmethylphosphonium bis(trifluoromethanesulfonyl) imide, 1-allyl-1-methylpyrrolidinium bis(trifluoromethanesulfonyl) imide, 1-allyl-1-methylpyrrolidinium bis(trifluoromethanesulfonyl) imide, 1-butyl-1-methylpyrrolidinium bis(fluorosulfonyl) imide, 1-butyl-1-methylpyrrolidinium trifluoromethanesulfonate,
1-methyl-1-propylpyrrolidinium bis(trifluoromethanesulfonyl) imide,
1-methyl-1-propylpyrrolidinium bis(fluorosulfonyl) imide,
1-(2-methoxyethyl)-1-methylpyrroli dinium bis(fluorosulfonyl) imide,
1-butyl-1-methylpiperidinium-bis(trifluoromethanesulfonyl) imide,
1-methyl-1-propylpiperidinium bis(fluorosulfonyl) imide, or triethylsulfonium bis(trifluoromethanesulfonyl) imide, or the combination of the ionic liquids.

Among them, as the catalyst carrier of this embodiment, carbon black, Ketjenblack, Ketjenblack EC, Nafion (registered trademark),
1-butyl-3-methylimidazolium bis(trifluoromethanesulfonyl) imide,
1-butyl-1-methylpyrrolidinium bis(fluorosulfonyl) imide, and
1-butyl-3-methylimidazolium tris(pentafluoroethyl) trifluorotrifluoro phosphate are preferred. One kind of the catalyst carriers may be used alone, or two or more kinds of them may be in combination use, and the combination use of carbon black and zinc oxide, the combination use of Ketjenblack EC and zinc oxide, the combination use of carbon black and molybdenum oxide, and the combination use of Ketjenblack EC and molybdenum oxide are preferred.

The electron conductor in the cathode catalyst layer 103 of this embodiment is not particularly limited as long as it is responsible for electron conduction. Examples thereof include carbon black, such as channel black, furness black, thermal black, acetylene black, Ketjenblack, and Ketjenblack EC, activated charcoal produced by carbonating and activating a material containing various carbon atoms, a carbon material, such as coke, natural graphite, artificial graphite, graphitized carbon, a metal mesh, such as nickel or titanium, and a metal foam.

Among them, as the electron conductor of this embodiment, in that the specific surface area is high and the electron conductivity is excellent, carbon black, Ketjenblack, Ketjenblack EC, a nickel metal mesh, a titanium metal mesh, and a metal foam are preferred, and further due to the excellent durability, a metal mesh and a metal foam of titanium are more preferred.

The electrolyte in the cathode catalyst layer 103 of this embodiment is not particularly limited as long as it is responsible for ion conduction. The electrolytes include a fluorine-based polymer electrolyte and a hydrocarbon-based polymer electrolyte. Examples of the fluorine-based polymer electrolyte include fluorinated sulfonic acid polymers such as Nafion (registered trademark) by DuPont, Aquivion (registered trademark) by Solvay S. A., FLEMION (registered trademark) by AGC Inc., and Aciplex (registered trademark) by Asahi Kasei Corporation, hydrocarbon-based sulfonic acid polymers, and partially fluorinated hydrocarbon-based sulfonic acid polymers. Examples of the hydrocarbon-based polymer electrolyte include sulphonated polyetherketone, sulphonated polyether sulfone, sulphonated polyether ether sulfone, sulphonated polysulfide, and sulphonated polyphenylene.

Among them, as the electrolyte in the cathode catalyst layer 103 of this embodiment, the one responsible for proton conduction is preferred, and Nafion, Aquivion, FLEMION, and Aciplex are preferred. The electrolyte may be mixed and used, and a perfluoro acid-based polymer, such as Nafion, is preferably contained.

The gas diffusion layer in the cathode catalyst layer 103 of this embodiment is not particularly limited as long as it is responsible for electron conduction, gas diffusion, and diffusion of electrolytic solution. Examples thereof include a carbon paper, a carbon felt, or a carbon cloth. Note that, in this Description, the cathode catalyst layer 103 including the complex, the cathode solid catalyst, or the complex and the catalyzer as the cathode solid catalyst and including the gas diffusion layer may be referred to as the gas diffusion electrode 133.

Examples of the carbon paper include TGP-H-060, TGP-H-090, TGP-H-120, TGP-H-060H, TGP-H-090H, and TGP-H-120H by Toray Industries, Inc., EC-TP1-030T, EC-TP1-060T, EC-TP1-090T, and EC-TP1-120T by Electrochem, Inc., and 22BB, 28BC, 36BB, and 39BB by SIGRACET. Examples of the carbon cloth include EC-CC1-060, EC-CC1-060T, and EC-CCC-060 by Electrochem, Inc., Torayca (registered trademark) cloth by Toray Industries, Inc., and CO6142, CO6151B, CO6343, CO6343B, CO6347B, CO6644B, CO1302, CO1303, CO5642, CO7354, CO7359B, CK6244C, CK6273C, and CK6261C. Examples of the carbon felt include H1410 and H2415 by Freudenberg.

Among them, as the gas diffusion layer in the cathode catalyst layer 103 of this embodiment, TGP-H-060, TGP-H-090, TGP-H-060H, TGP-H-090H, and EC-TP1-060T are preferred.

In the ammonia production method of this embodiment, examples of a proton source disposed in the electrolytic apparatus include an electrolyte membrane 102 disposed beside the cathode catalyst layer 103, an electrolytic solution derived from the electrolyte membrane, and an electrolytic solution of an electrolytic solution tank disposed beside the cathode catalyst layer 103, and as long as the electrolytic solution is a solution containing an electrolyte and responsible for proton conduction, the electrolytic solution is not particularly limited. One kind of the proton sources may be used alone, or two or more kinds of them may be in combination use.

Examples of the solution in the electrolytic solution in the ammonia production method of this embodiment include water, ionic liquid, methanol, isopropyl alcohol, N,N-dimethylformamide, N,N-dimethylacetamide, dimethyl sulfoxide, N-methylpyrrolidone, diethylamine, hexamethylphosphonic triamide, acetic acid, acetonitrile, methylene chloride, trifluoroethanol, nitromethane, sulfolane, pyridine, tetrahydrofuran, dimethoxyethane, and propylene carbonate, and water and ionic liquid are preferred.

Examples of the ionic liquid include imidazolium salt, pyridinium salt, ammonium salt, phosphonium salt, pyrrolidinium salt, piperidinium salt, or sulfonium salt, which are described above.

An acid, such as sulfuric acid or trifluoromethanesulfonic acid, can be added to the ionic liquid in use. Preferably, the ionic liquid used with addition of the acid includes 1-butyl-3-methylimidazolium bis(trifluoromethanesulfonyl) imide, 1-butyl-1-methylpiperidinium-bis(trifluoromethanesulfonyl) imide, and 1-butyl-3-methylimidazolium tris(pentafluoroethyl) trifluorotrifluoro phosphate.

The electrolyte contained in the electrolytic solution in the ammonia production method of this embodiment includes a cation used alone or a plurality of cations used in combination: for example, a proton, lithium ion, sodium ion, potassium ion, imidazolium ion, pyridinium ion, quaternary ammonium ion, phosphonium ion, pyrrolidinium ion, and phosphonium ion or, on the other hand, an anion used alone or a plurality of anions used in combination: for example, chlorine ion, bromine ion, iodine ion, tetrafluoroborate, trifluoro (trifluoromethyl) borate, dimethylphosphate ion, diethylphosphate ion, hexafluorophosphate, tris(pentafluoroethyl) trifluorophosphate, trifluoroacetate, methylsulfate, trifluoromethanesulfonate, bis(trifluoromethanesulfonyl) imide, perchlorate ion, sulfate ion, and nitrate ion. One kind of the electrolytes may be used alone, or two or more kinds of them may be used in combination.

Examples of the quaternary ammonium ions in the electrolyte include triethylpentylammonium ions, diethyl(methyl) propylammonium ions, methyltri-n-octylammonium ions, trimethylpropylammonium ions,
cyclohexyltrimethylammonium ions, diethyl(2-methoxyethyl)-methylammonium ions,
ethyl(2-methoxyethyl)-dimethylammonium ions,
ethyl(3-methoxypropyl)dimethylammonium ions,
ethyl(dimethyl) (2-phenylethyl)-ammonium ions, tetramethylammonium ions,
tetraethylammonium ions, triethylpentylammonium ions, tetra-n-butylammonium ions,
diethyl(methyl) propylammonium ions, methyltri-n-octylammonium ions,
trimethylpropylammonium ions, cyclohexyltrimethylammonium ions,
diethyl(2-methoxyethyl)-methylammonium ions,
ethyl(2-methoxyethyl)-dimethylammonium ions,
ethyl(3-methoxypropyl)dimethylammonium ions, and
ethyl(dimethyl) (2-phenylethyl)-ammonium ions.

Specific examples of the imidazolium ions, the pyridinium ions, the phosphonium ions, the pyrrolidinium ions, and the phosphonium ions in the electrolyte include the ones described above.

The cations as the electrolyte contained in the electrolytic solution of this embodiment are preferably protons, imidazolium ions, and pyrrolidinium ions, and the anions as the electrolyte are preferably perchlorate ions and sulfate ions.

A preferred cathode electrolytic solution 106 used in a cathode electrolytic solution tank 105 of this embodiment specifically includes water, a sulfuric acid aqueous solution, and 1-butyl-3-methylimidazolium bis(trifluoromethanesulfonyl) imide, and one kind of them may be used alone, or two or more kinds of them may be used in combination.

A preferred anode electrolytic solution 116 used in an anode electrolytic solution tank 115 of this embodiment specifically includes water and a sulfuric acid aqueous solution.

In the ammonia production method of this embodiment, the electrolyte membrane 102 includes a polymer electrolyte membrane. Examples of the polymer electrolyte membrane include NEOSEPTA (registered trademark) by ASTOM Corporation, Selemion (registered trademark) by AGC Inc., Aciplex (registered trademark) by Asahi Kasei Corporation, Fumasep (registered trademark) by Fumatech, fumapem (registered trademark) by Fumatech, Nafion (registered trademark) by DuPont, Aquivion (registered trademark) by Solvay S.A., FLEMION (registered trademark) by AGC Inc., and GORE-SELECT (registered trademark) by Gore & Associates. As the electrolyte membrane 102, Aciplex (registered trademark) by Asahi Kasei Corporation, Nafion (registered trademark) by DuPont, Aquivion (registered trademark) by Solvay S.A., and FLEMION (registered trademark) by AGC Inc. are preferred.

In the ammonia production method of this embodiment, the reaction temperature is preferably from −40° C. to 120° C., and more preferably from 0° C. to 50° C., which is a normal temperature. The reaction atmosphere may be a pressurized atmosphere and usually may be a normal pressure atmosphere. The reaction time is not particularly limited, but it is usually only necessary to be set in a range of several tens of minutes to several tens of hours, and the reaction can be performed continuously. However, the reaction can be stopped in the middle, and, for example, after performing a reaction for several hours, the reaction can be stopped once and performed again.

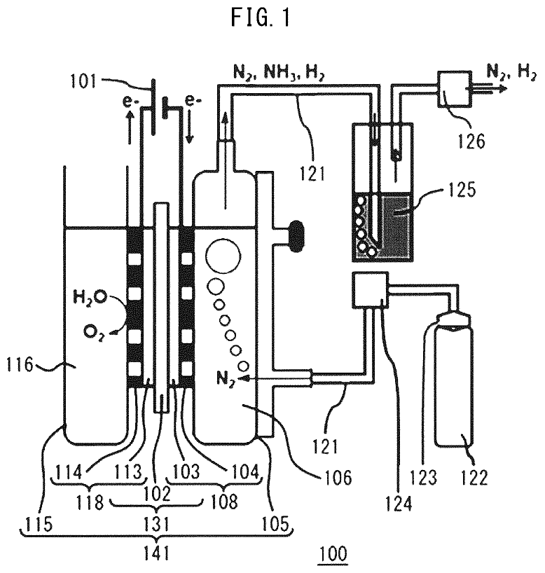

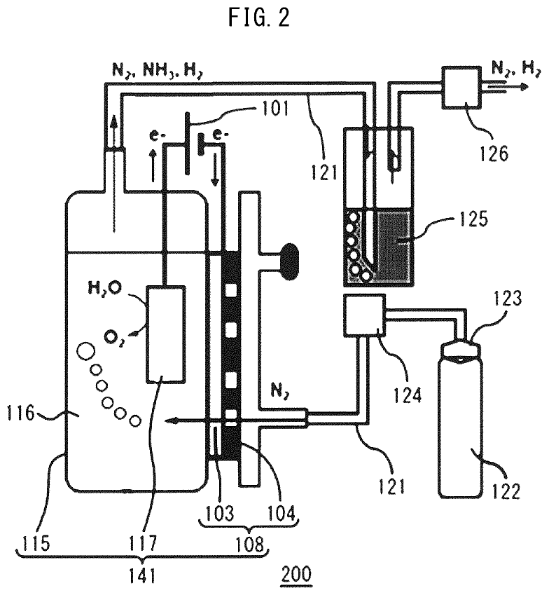

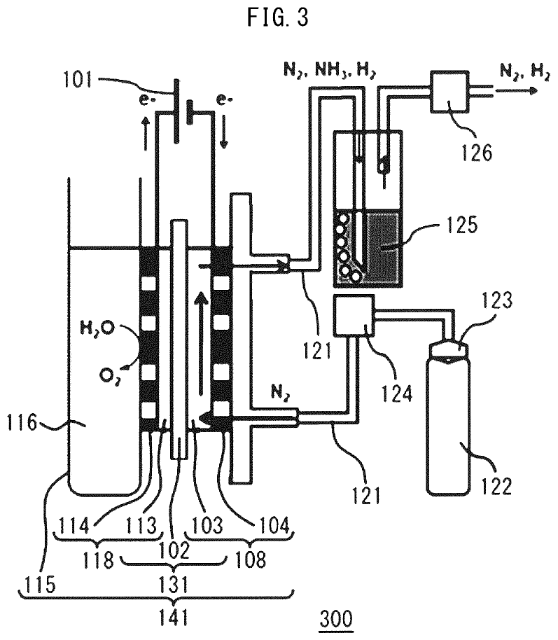

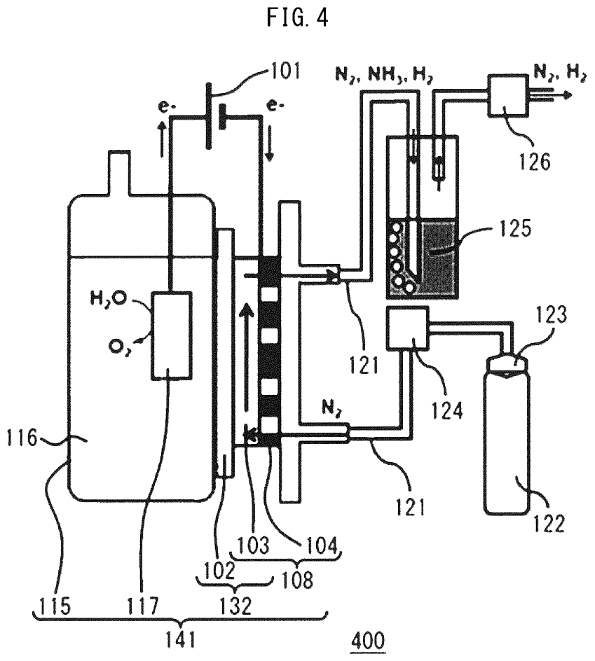

An electrolytic apparatus, which is the ammonia production method and the ammonia production apparatus of this embodiment, will be described below. Here, as an example, FIG. 1 illustrates an electrolytic apparatus of ammonia (first) 100 of Example 1 for producing ammonia, FIG. 2 illustrates an electrolytic apparatus of ammonia (second) 200 of Example 2 for producing ammonia, FIG. 3 illustrates an electrolytic apparatus of ammonia (third) 300 of Example 3 for producing ammonia, and FIG. 4 illustrates an electrolytic apparatus of ammonia (fourth) 400 of Example 4 for producing ammonia.

The electrolytic apparatus of ammonia (first) 100 of this embodiment is an ammonia production apparatus that includes a cathode 108, an anode 118, and a membrane electrode assembly 131 that integrates the cathode catalyst layer 103 and an anode catalyst layer 113 via the electrolyte membrane 102. The cathode catalyst layer 103 is assembled to one side of the electrolyte membrane 102, a cathode current collector 104 is disposed outside the cathode catalyst layer 103, the anode catalyst layer 113 is assembled to the other side of the electrolyte membrane 102, and an anode current collector 114 is disposed outside the anode catalyst layer 113.

The cathode catalyst layer 103 contains a complex and a cathode solid catalyst, and the anode catalyst layer 113 contains an anode solid catalyst.

The production apparatus includes the cathode electrolytic solution tank 105 of the cathode electrolytic solution 106 in liquid contact with the cathode 108 of the membrane electrode assembly 131, the anode electrolytic solution tank 115 of an anode electrolytic solution 116 in liquid contact with the anode 118 of the membrane electrode assembly 131, a power supply (power supply device 101) that supplies the cathode 108 with electrons, a proton source that supplies the cathode 108 with protons, and means that supplies the cathode electrolytic solution 106 and the cathode 108 with a nitrogen gas. The proton source is the electrolyte membrane 102, the cathode electrolytic solution 106, the anode electrolytic solution 116, and both of the electrolyte membrane 102 and the cathode electrolytic solution 106 or both of the electrolyte membrane 102 and the anode electrolytic solution 116. Further, the electrolytic apparatus of ammonia (first) 100 of this embodiment is an ammonia production apparatus that produces ammonia from nitrogen molecules by electrolysis.

The means that supplies a nitrogen gas is means that performs a supply from a nitrogen cylinder 122 through a pipe 121 via a regulator 123 of the nitrogen cylinder and a mass flow controller 124 of a nitrogen gas.

The ammonia generated in the cathode 108 can be trapped at the cathode electrolytic solution tank 105 of the cathode electrolytic solution 106 and a diluted sulfuric acid aqueous solution tank for trapping ammonia 125. Secondarily produced hydrogen and unreacted nitrogen pass through the pipe 121, pass through the diluted sulfuric acid aqueous solution tank for trapping ammonia 125, and are discharged outside through a draft device 126.

The electrolytic apparatus of ammonia (second) 200 of this embodiment is an ammonia production apparatus that includes the cathode 108 formed of the cathode catalyst layer 103 and the cathode current collector 104 and a metal plate electrode 117 in an anode.

The cathode catalyst layer 103 contains a complex and a cathode solid catalyst and is the gas diffusion electrode 133.

The production apparatus includes the anode electrolytic solution tank 115 of the anode electrolytic solution 116 in liquid contact with the cathode catalyst layer 103 and includes the power supply (power supply device 101) that supplies the cathode 108 with electrons, a proton source that supplies the cathode 108 with protons, and means that supplies the cathode 108 with a nitrogen gas. As the gas diffusion layer of the cathode catalyst layer 103, the use of a carbon paper on which a water repellent treatment has been performed with fluorine resin formed of polytetrafluoroethylene (hereinafter also referred to as “PTFE”) for the cathode catalyst layer 103 is preferred, and specifically, TGP-H-060H, TGP-H-090H, TGP-H-120H, EC-TP1-030T, EC-TP1-060T, EC-TP1-090T, or EC-TP1-120T is preferred. The proton source is the anode electrolytic solution 116. Further, the electrolytic apparatus of ammonia (second) 200 of this embodiment is an ammonia production apparatus that produces ammonia from nitrogen molecules by electrolysis.

The means that supplies a nitrogen gas is means that performs a supply from the nitrogen cylinder 122 through the pipe 121 via the regulator 123 of the nitrogen cylinder and the mass flow controller 124 of a nitrogen gas.

The ammonia generated in the cathode 108 can be trapped at the anode electrolytic solution tank 115 of the anode electrolytic solution 116 and the diluted sulfuric acid aqueous solution tank for trapping ammonia 125. Secondarily produced hydrogen and unreacted nitrogen pass through the pipe 121, pass through the diluted sulfuric acid aqueous solution tank for trapping ammonia 125, and are discharged outside through the draft device 126.

The electrolytic apparatus of ammonia (third)300 of this embodiment is an ammonia production apparatus that includes the cathode 108, the anode 118, and the membrane electrode assembly 131 that integrates the cathode catalyst layer 103 and the anode catalyst layer 113 via the electrolyte membrane 102. The cathode catalyst layer 103 is assembled to one side of the electrolyte membrane 102, the cathode current collector 104 is disposed outside the cathode catalyst layer 103, the anode catalyst layer 113 is assembled to the other side of the electrolyte membrane 102, and the anode current collector 114 is disposed outside the anode catalyst layer 113.

The cathode catalyst layer 103 contains a complex and a cathode solid catalyst, and the anode catalyst layer 113 contains an anode solid catalyst.

The production apparatus includes the anode electrolytic solution tank 115 of the anode electrolytic solution 116 in liquid contact with the anode 118 of the membrane electrode assembly 131, the power supply (power supply device 101) that supplies the cathode 108 with electrons, the proton source that supplies the cathode 108 with protons, and the means that supplies the cathode electrolytic solution 106 and the cathode 108 with a nitrogen gas. The proton source is the electrolyte membrane 102, the anode electrolytic solution 116, or both of the electrolyte membrane 102 and the anode electrolytic solution 116. Further, the electrolytic apparatus of ammonia (third)300 of this embodiment is an ammonia production apparatus that produces ammonia from nitrogen molecules by electrolysis.

The means that supplies a nitrogen gas is means that performs a supply from the nitrogen cylinder 122 through the pipe 121 via the regulator 123 of the nitrogen cylinder and the mass flow controller 124 of a nitrogen gas.

The ammonia generated in the cathode 108 can be trapped at the diluted sulfuric acid aqueous solution tank for trapping ammonia 125. Secondarily produced hydrogen and unreacted nitrogen pass through the pipe 121, pass through the diluted sulfuric acid aqueous solution tank for trapping ammonia 125, and are discharged outside through the draft device 126.

The electrolytic apparatus of ammonia (fourth) 400 of this embodiment is the ammonia production apparatus that includes the cathode membrane electrode assembly 132 in which the cathode catalyst layer 103 is assembled to one side of the electrolyte membrane 102, the cathode 108 formed of the cathode current collector 104, and the metal plate electrode 117 in an anode.

The cathode catalyst layer 103 includes a complex and a cathode solid catalyst.

The production apparatus includes the anode electrolytic solution tank 115 of the anode electrolytic solution 116 in liquid contact with the electrolyte membrane 102 of the cathode membrane electrode assembly 132 and includes the power supply (power supply device 101) that supplies the cathode 108 with electrons, a proton source that supplies the cathode 108 with protons, and means that supplies the cathode 108 with a nitrogen gas. The proton source is the electrolyte membrane 102, the anode electrolytic solution 116, or both of the electrolyte membrane 102 and the anode electrolytic solution 116. Further, the electrolytic apparatus of ammonia (fourth) 400 of this embodiment is an ammonia production apparatus that produces ammonia from nitrogen molecules by electrolysis.

The means that supplies a nitrogen gas is means that performs a supply from the nitrogen cylinder 122 through the pipe 121 via the regulator 123 of the nitrogen cylinder and the mass flow controller 124 of a nitrogen gas.

The ammonia generated in the cathode 108 can be trapped at the diluted sulfuric acid aqueous solution tank for trapping ammonia 125. Secondarily produced hydrogen and unreacted nitrogen pass through the pipe 121, pass through the diluted sulfuric acid aqueous solution tank for trapping ammonia 125, and are discharged outside through the draft device 126.

Examples of the cathode current collector 104 and the anode current collector 114 in the electrolytic apparatus of this embodiment include an alloy containing two or more kinds of carbon, metal, oxide, and metal, and oxide, stainless steel, indium tin oxide, and indium zinc oxide containing two or more kinds of metals. Among them, examples of the metal include titanium, vanadium, chromium, manganese, iron, cobalt, nickel, copper, zinc, niobium, molybdenum, ruthenium, rhodium, silver, tantalum, tungsten, osmium, iridium, indium, platinum, and gold. Examples of the oxide include titanium oxide, vanadium oxide, chromium oxide, manganese oxide, iron oxide, cobalt oxide, nickel oxide, copper oxide, zinc oxide, niobium pentoxide, molybdenum oxide, ruthenium oxide, rhodium oxide, silver oxide, tantalum oxide, tungsten oxide, osmium oxide, iridium oxide, indium oxide, platinum oxide, and gold oxide.

The shape of the current collector is not particularly limited as long as the gas or electrolytic solution passes through the current collector, and examples thereof include a punched shape, a linear shape, a bar shape, a plate shape, a foil shape, a net shape, a woven fabric, a nonwoven fabric, an expanded shape, a porous body, and a foam. To reduce corrosion during production by electrolysis, a current collector subjected to gold plating or the like can also be used.

The nitrogen gas in the electrolytic apparatus of this embodiment can also be supplied by controlling the flow rate from the nitrogen cylinder 122 by the regulator 123 of the nitrogen cylinder and the mass flow controller 124 of the nitrogen gas. For example, a method of bubbling and supplying the nitrogen gas to the electrolytic solution in the cathode electrolytic solution tank 105 in FIG. 1 and the anode electrolytic solution tank 115 in FIG. 2 is also possible, and as illustrated in FIG. 3 and FIG. 4, supplying the nitrogen gas directly to the cathode catalyst layer 103 through the hole of the cathode current collector 104 is also possible.

The electrolytic reaction for producing ammonia in the cathode catalyst layer 103 in the electrolytic apparatus of this embodiment will be described. The reaction of generating ammonia occurs from three of the nitrogen gas supplied to the cathode 108, the protons supplied to the cathode 108, and the electrons supplied from the power supply device 101 by the catalyzer in the form in combination of the complex and the solid catalyst of this embodiment, and the reaction formula can be described as “N₂+6e⁻+6H⁺→2NH₃.”

While ammonia is produced in the cathode catalyst layer 103, the reaction occurs also in two of hydroxonium ions or water and electrons in the cathode catalyst layer, and therefore hydrogen is secondarily produced. This by-product hydrogen can be in a dissociated on the solid catalyst or on the catalyst carrier. For example, Non-Patent Document, Shriver and Atkins' Inorganic Chemistry (First Volume), Sixth Edition, page 358 describes that, on a platinum catalyst of a metal catalyst, adsorbed hydrogen is activated by homolytic dissociation into hydrogen atoms, and on zinc oxide of metal oxide, adsorbed hydrogen is activated by heterolytic dissociation into protons and hydrides. It is inferred that the activated hydrogen atoms on the solid catalyst, the protons, and the hydrides promote the reaction to generate ammonia.

The ammonia generated in the cathode 108 can be transmitted to the diluted sulfuric acid aqueous solution tank for trapping ammonia 125 together with the secondarily produced hydrogen and the unreacted nitrogen and can be trapped to the electrolytic solution used in the cathode electrolytic solution tank 105 or the anode electrolytic solution tank 115. In this case, from the aspect of recovery and recycling, the electrolytic solution used in the cathode electrolytic solution tank 105 is preferably water or a diluted sulfuric acid aqueous solution. By circulating the electrolytic solution in the cathode electrolytic solution tank 105 with a pump, the efficiency of ammonia trap can be enhanced.

A mixed gas composed of the ammonia generated in the cathode catalyst layer 103 in the electrolytic apparatus of this embodiment, the secondarily produced hydrogen, and the unreacted nitrogen can selectively trap ammonia by the use of water and the diluted sulfuric acid aqueous solution as described above. Therefore, the mixed gas of the secondarily produced hydrogen and the nitrogen can be simultaneously taken out, and hydrogen, which is effective from the aspect of energy carrier, can also be obtained in this embodiment. Additionally, for safety, the secondarily produced hydrogen can be discharged to the outside through the draft device 126.

The use of a putty, a seal agent, or the like at the coupling part of the gas pipe and the electrolytic solution tank allows reducing a gas leakage and a liquid leakage.

The electrolytic reaction in the anode catalyst layer 113 or the metal plate electrode 117 in the electrolytic apparatus of this embodiment will be described. The catalyst of the anode 118 causes a reaction of generating oxygen, electrons, and protons from water, and the reaction formula can be described as “2H₂O→O₂+4e⁻+4H⁺.” The generated protons move to the cathode 108 through the electrolyte membrane 102 or the electrolytic solution, and the electrons move to the power supply device 101 through the anode current collector 114 or the metal plate electrode 117. While the generated oxygen is partially dissolved in the water of the anode electrolytic solution tank 115, the generated oxygen can be released to the atmosphere, and bubbling the nitrogen gas in the anode electrolytic solution tank 115 allows forcibly getting rid of oxygen.

The anode catalyst layer 113 in the electrolytic apparatus of this embodiment includes the catalyst carrier, the electrolyte, and the gas diffusion layer besides the solid catalyst. Note that, in this Description, the anode catalyst layer 113 that includes the anode solid catalyst, the catalyst carrier, the electron conductor, the electrolyte, and the gas diffusion layer is described as the gas diffusion electrode 133 in some cases.

The solid catalyst in the anode catalyst layer 113 of the electrolytic apparatus of this embodiment is defined as the anode solid catalyst. The anode solid catalyst includes ones same as the ones described in the solid catalyst and the cathode solid catalyst in the ammonia production method of this embodiment. Specific examples thereof include a metal, such as an iridium oxide (IV) powder catalyst, a platinum catalyst, a gold catalyst, a silver catalyst, a ruthenium catalyst, an iridium catalyst, a rhodium catalyst, a palladium catalyst, an osmium catalyst, a tungsten catalyst, a lead catalyst, an iron catalyst, a chromium catalyst, a cobalt catalyst, a nickel catalyst, a manganese catalyst, a vanadium catalyst, a molybdenum catalyst, a gallium catalyst, and an aluminum catalyst, and alloys thereof. Among them, as the anode solid catalyst, an iridium oxide (IV) powder catalyst and a platinum catalyst are preferred.

The catalyst carrier in the anode catalyst layer 113 of this embodiment may be responsible for electron conduction, and is not particularly limited as long as it supports the catalyst of this embodiment. Examples of the catalyst carrier include a carbon black, a carbon material, a metal mesh, a metal foam, a metal oxide, and a composite oxide.

Examples of the carbon black include channel black, furness black, thermal black, acetylene black, Ketjenblack, and Ketjenblack EC. Examples of the carbon material include activated carbon obtained by carbonizing and activating a material containing various kinds of carbon atoms, coke, natural graphite, artificial graphite, and graphitized carbon. The metal mesh includes a metal mesh, such as nickel or titanium. Examples of the metal foam include metal foam, such as aluminum, magnesium, titanium, zinc, iron, tin, lead, or alloys containing thereof. Examples of the metal oxide include aluminum oxide, zirconium oxide, titanium oxide, vanadium oxide, chromium oxide, manganese oxide, iron oxide, cobalt oxide, nickel oxide, copper oxide, zinc oxide, niobium pentoxide, molybdenum oxide, ruthenium oxide, rhodium oxide, silver oxide, tantalum oxide, tungsten oxide, osmium oxide, iridium oxide, indium oxide, platinum oxide, gold oxide, magnesium oxide, or silica. Examples of the composite oxide include silica-alumina and silica-magnesia. Among them, as the catalyst carrier, in that the specific surface area is high and the electron conductivity is excellent, carbon black, Ketjenblack, Ketjenblack EC, a nickel metal mesh, a titanium metal mesh, and a metal foam are preferred, and further due to the excellent durability, a metal mesh and a metal foam of titanium are more preferred.

The electrolyte in the anode catalyst layer 113 of this embodiment is not particularly limited as long as it is responsible for ion conduction. Ones same as the ones described in the electrolyte in the cathode catalyst layer 103 of this embodiment are included, and specific examples of the electrolyte include fluorinated sulfonic acid polymers such as Nafion (registered trademark) by DuPont, Aquivion (registered trademark) by Solvay S. A., FLEMION (registered trademark) by AGC Inc., and Aciplex (registered trademark) by Asahi Kasei Corporation, hydrocarbon-based sulfonic acid polymers, and partially fluorinated hydrocarbon-based sulfonic acid polymers. Among them, as the electrolyte, the one responsible for proton conduction is preferred, and Nafion, Aquivion, FLEMION, and Aciplex are preferred. The above-described electrolyte may be mixed and used, and a perfluoro acid-based polymer, such as Nafion, is preferably contained.

The gas diffusion layer in the anode catalyst layer 113 of this embodiment is not particularly limited as long as it is responsible for electron conduction, gas diffusion, and diffusion of electrolytic solution. Ones same as the ones described in the gas diffusion layer in the cathode catalyst layer 103 of this embodiment are included, a carbon paper is preferred, and specific examples include TGP-H-060, TGP-H-090, TGP-H-120, TGP-H-060H, TGP-H-090H, and TGP-H-120H by Toray Industries, Inc., EC-TP1-030T, EC-TP1-060T, EC-TP1-090T, and EC-TP1-120T by Electrochem, Inc., and 22BB, 28BC, 36BB, and 39BB by SIGRACET. Among them, as the gas diffusion layer, TGP-H-060, TGP-H-090, TGP-H-060H, TGP-H-090H, and EC-TP1-060T are preferred.

Specific examples of the metal of the metal plate electrode 117 of this embodiment include a metal such as stainless steel, indium tin oxide, indium zinc oxide, titanium, vanadium, chromium, manganese, iron, cobalt, nickel, copper, zinc, niobium, molybdenum, ruthenium, rhodium, silver, tantalum, tungsten, osmium, iridium, indium, platinum, and gold, and alloys thereof. Among them, platinum is preferred. Additionally, examples of the shape of the metal plate electrode 117 include a linear shape, a bar shape, a plate shape, a foil shape, a mesh shape, a woven fabric, a nonwoven fabric, an expanded shape, a porous body, and a foam, and a mesh shape and a porous body are preferred.

The present invention is not limited to the embodiments described above but obviously can be embodied by a variety of aspects as long as they fall into the technical scope of the present invention.

The following describes examples of the present invention. However, the present invention is not limited to the examples described below.

### EXAMPLES

### Synthesis Example 1: Producing Calcined Body (a1)

A mixture (2.09 g) obtained by mixing Ketjenblack EC (produced by Lion Specialty Chemicals Co., Ltd., EC300J, 1.08 g) and phloroglucinol (produced by Tokyo Chemical Industry Co., Ltd., 1.08 g) in a mortar was placed in an alumina crucible. The crucible was installed in a desk gas replacement furnace KDF-75 (produced by DENKEN-HIGHDENTAL Co., Ltd.), a nitrogen atmosphere was set in a nitrogen flow, and after that the temperature was increased at a rate of 3° C. per minute, and calcination was performed at a calcining temperature of 250° C. for 2 hours. After the calcination, the product was cooled down to a room temperature while the nitrogen atmosphere was maintained, and the black calcined body (a1) (1.91 g, 91% of it was recovered when the preparation weight was 100%) was obtained.

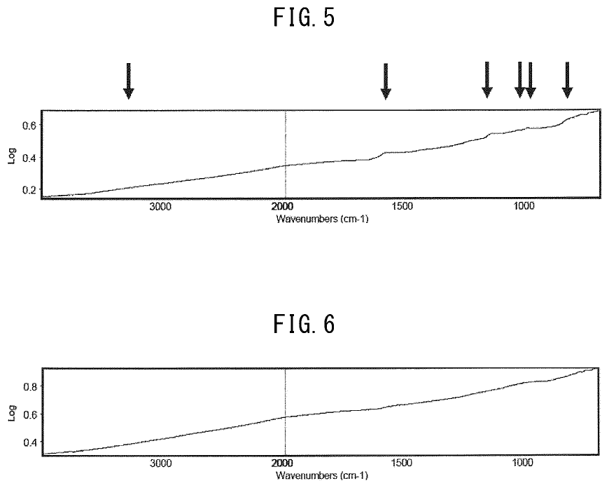

IR measurement by germanium ATR method was performed. FIG. 5 illustrates a chart diagram of the IR measurement of the calcined body (a1).

For comparison, IR measurement of the Ketjenblack EC (produced by Lion Specialty Chemicals Co., Ltd., EC300J) as the raw material was also performed. FIG. 6 illustrates a chart diagram of the IR measurement of the Ketjenblack EC.

Through comparison between FIG. 5 and FIG. 6, new peaks that were absent in the chart of IR measurement of the Ketjenblack EC were confirmed in the chart of the IR measurement in FIG. 5. FIG. 5 indicates the new peaks by the arrows.

### Synthesis Example 2: Producing Rare Earth Metal-Carbon-Based Binder (b1)

A mixture (1.65 g) obtained by mixing the calcined body (a1) (0.60 g) produced in Synthesis Example 1 and tris(acetylacetonato) cerium (III) trihydrate (produced by FUJIFILM Wako Chemical Corporation, 1.05 g, 2.14 mmol) in a mortar was placed in an alumina crucible. The crucible was installed in a desk gas replacement furnace KDF-75 (produced by DENKEN-HIGHDENTAL Co., Ltd.), a nitrogen atmosphere was set in a nitrogen flow, and after that the temperature was increased at a rate of 13° C. per minute, and calcination was performed at a calcining temperature of 400° C. for 1 hour. After the calcination, the product was cooled down to a room temperature while the nitrogen atmosphere was maintained, and the rare earth metal-carbon-based binder (b1) was obtained as black powder (0.85 g, 51% of it was recovered when the preparation weight was 100%) was obtained.

### Synthesis Example 3: Producing Rare Earth Metal-Carbon-Based Binder (b2)

The calcined body (a1) (1.00 g) produced in Synthesis Example 1, tetrahydrofuran (50 mL), tris(acetylacetonato) cerium (III) trihydrate (produced by FUJIFILM Wako Chemical Corporation, 4.67 g, 9.50 mmol) were sequentially added to a reaction container. Next, powder of sodium hydride (240.0 mg, 10.0 mmol) was dividedly added to the reaction container. The reaction mixture was installed in an oil bus set to 70° C., and stirred for 24 hours for reaction. After ending the reaction, after the temperature was set to 20 to 25° C. as a room temperature, ion exchanged water (10 mL) and 2 mol/L of sulfuric acid (20 mL) were added to the reaction container in this order, and the product was stirred for 1 hour. Next, the reaction mixture was filtered with a vacuum filter with a silica filter paper attached, and after that the product was cleaned with 2 mol/L of sulfuric acid (10 mL). Next, the product was cleaned with ion exchanged water until a hydrogen ion index (pH) of the filtrate became neutral. After the coarse material was added to an eggplant flask, the eggplant flask was installed to an evaporator coupled to a vacuum pump, the coarse material was dried until it had a constant weight at the bus temperature of 90° C., and the rare earth metal-carbon-based binder (b2) was obtained as a black solid (1.792 g).

### Synthesis Example 4: Producing Rare Earth Metal-Carbon-Based Binder (b3)

The calcined body (a1) (0.60 g) produced in Synthesis Example 1, tetrahydrofuran (30 mL), samarium triisopropoxide (produced by FUJIFILM Wako Chemicals Corporation, 2.00 g, 6.10 mmol) were sequentially added to a reaction container. Next, powder of sodium hydride (240.0 mg, 10.0 mmol) was dividedly added to the reaction container. The reaction mixture was installed in an oil bus set to 70° C., and stirred for 24 hours for reaction. After ending the reaction, after the temperature was set to 20 to 25° C. as a room temperature, ion exchanged water (5 mL) and 2 mol/L of sulfuric acid (10 mL) were added to the reaction container in this order and the product was stirred for 1 hour. Next, the reaction mixture was filtered with a vacuum filter with a silica filter paper attached, and after that the product was cleaned with 2 mol/L of sulfuric acid (5 mL). Next, the product was cleaned with ion exchanged water until a hydrogen ion index (pH) of the filtrate became neutral. After the coarse material was added to an eggplant flask, the eggplant flask was installed to an evaporator coupled to a vacuum pump, the coarse material was dried until it had a constant weight at the bus temperature of 90° C., and the rare earth metal-carbon-based binder (b3) was obtained as a black solid (0.779 g).

In the following test examples, the production of the electrolytic apparatus for producing ammonia and the production of ammonia by the electrolytic apparatus were performed in the following manner.

### Test Example 1

1. Production of Electrolytic Apparatus that Produces Ammonia

The cathode catalyst layer 103 as a catalyzer for producing ammonia was produced as follows. Catalyst ink A used for the cathode 108 is ink for applying the cathode solid catalyst of this embodiment to the cathode catalyst layer 103. The catalyst ink A was prepared using a carbon black supported platinum catalyst as the solid catalyst (produced by TANAKA Kikinzoku Kogyo, platinum content: 46.6 weight %, product name “TEC10E50E”), the rare earth metal-carbon-based binder (b1), 2-propanol (produced by FUJIFILM Wako Pure Chemical Corporation), and a Nafion dispersion solution as the electrolyte (produced by FUJIFILM Wako Pure Chemical Corporation, product name “5% Nafion dispersion solution DE520 CS type”). The carbon-supported platinum catalyst, the rare earth metal-carbon-based binder (b1), the Nafion dispersion solution, and the 2-propanol were added to a glass vial in this order, and the obtained dispersion solution was prepared as the catalyst ink A by irradiation with an ultrasonic wave for 30 minutes using an ultrasonic cleaner ASU-6 produced by AS ONE Corporation, with an oscillating power set at “High.”

### <Conditions for Preparation of Catalyst Ink A>

Specifically, the catalyst ink A was prepared using an electrocatalyst as a platinum supported carbon (100.0 mg, produced by TANAKA Kikinzoku Kogyo, platinum content: 46.5 weight %, product name “TEC10E50E”), the rare earth metal-carbon-based binder (b1) (76.1 mg), the Nafion dispersion solution (1.556 g, produced by FUJIFILM Wako Chemicals Corporation, product name “5% Nafion dispersion solution DE520 CS type,” 77.8 mg as Nafion solid content), and 2-propanol (2.5 mL, produced by FUJIFILM Wako Chemicals Corporation).

The proportion of the Nafion (hereinafter also referred to as “ionomer”) in the catalyst ink described above will be described. In the catalyst ink A, the proportion of the ionomer (weight %) calculated from the following formula was set to 31 weight %.

$$Proportion of ionomer ( weight \% ) = [ solid content of ionomer ( weight ) / [ \{ carbon - supported platinum catalyst ( weight ) + solid content of ionomer ( weight ) + rare earth metal - carbon - based binder ( weight ) \} ] ] \times 100$$

Next, the catalyst ink A was applied to a fixed carbon paper (produced by Toray Industries, Inc., product name “TGP-H-060H”) at a room temperature of 20 to 25° C., and water and alcohols as solvent components in the catalyst ink were dried on a hot plate set to 80° C. The application amount was adjusted such that the amount of platinum per 1 cm² became 1.0 mg and the application was performed. Thus, the gas diffusion electrode 133 (GDE) containing the Nafion as the electrolyte, the carbon-supported platinum catalyst as the solid catalyst, and the rare earth metal-carbon-based binder (b1) as the reaction-field forming material was produced. Specifically, the gas diffusion electrode 133 was the gas diffusion electrode 133 that was a square of 2.7×2.7 cm² and applied with the platinum catalyst (7.3 mg) as the solid catalyst and the rare earth metal-carbon-based binder (12.0 mg), and was referred to as “GDE-Cathode-1.”

Next, catalyst ink B for applying the complex of this embodiment to the cathode catalyst layer 103 was produced. A solution obtained by dissolving a molybdenum complex expressed by Formula (A1-1)

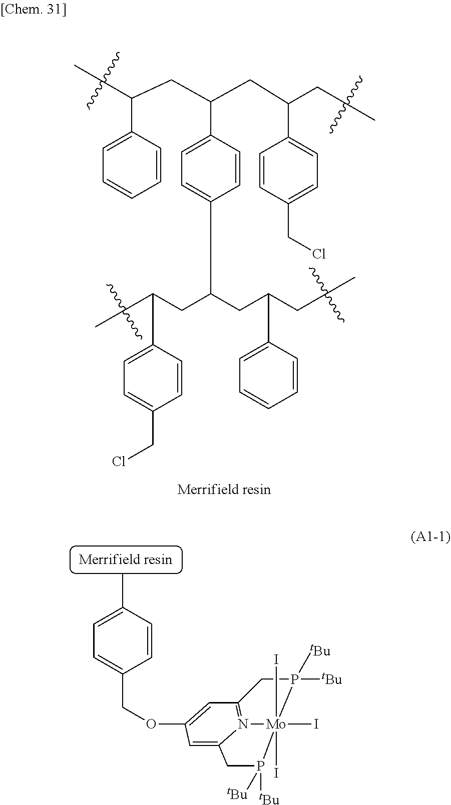

(In 5.8 mg, the number of moles per molybdenum was 4.2 μmol by an ICP emission spectrochemical analysis method) into 1-butyl-3-methylimidazolium bis(trifluoromethanesulfonyl) imide (1.0 mL) was used as the catalyst ink B. The molybdenum complex expressed by Formula (A1-1) was synthesized by the method described in Non-Patent Document, Chem. Lett., 2019, Volume 48, Pages 693 to 695. The catalyst ink B (10 μL) was applied to the “GDE-Cathode-1” of the gas diffusion electrode 133 to produce the cathode catalyst layer 103. Specifically, the gas diffusion electrode 133 as the cathode catalyst layer 103 was the gas diffusion electrode 133 that was a square of 2.7×2.7 cm² and applied with the platinum catalyst (7.3 mg) as the solid catalyst, the rare earth metal-carbon-based binder (12.0 mg), and the molybdenum complex (0.058 mg, 0.042 μmol per molybdenum) expressed by Formula (A1-1), and was referred to as “GDE-Cathode-2.”

The anode catalyst layer 113 was produced as follows. Catalyst ink C is ink for applying the anode solid catalyst of this embodiment to the anode catalyst layer 113. The catalyst ink C was prepared using a carbon black supported platinum catalyst as the solid catalyst (produced by TANAKA Kikinzoku Kogyo, platinum content: 46.6 weight %, product name “TEC10E50E”), 2-propanol (produced by FUJIFILM Wako Pure Chemical Corporation), and a Nafion dispersion solution as the electrolyte (produced by FUJIFILM Wako Pure Chemical Corporation, product name “5% Nafion dispersion solution DE520 CS type”). The carbon-supported platinum catalyst, the Nafion dispersion solution, and the 2-propanol were added to a glass vial in this order, and the obtained dispersion solution was prepared as the catalyst ink C by irradiation with an ultrasonic wave for 30 minutes using an ultrasonic cleaner ASU-6 produced by AS ONE Corporation, with an oscillating power set at “High.” Next, the catalyst ink C was applied to a fixed carbon paper (produced by Toray Industries, Inc., product name “TGP-H-060H”) at a room temperature of 20 to 25° C., and water and alcohols as solvent components in the catalyst ink were dried on a hot plate set at 80° C. The application amount was adjusted such that the amount of platinum per 1 cm² became 1.0 mg and the application was performed. Thus, the gas diffusion electrode 133 containing the Nafion as the electrolyte and the carbon-supported platinum catalyst as the solid catalyst was produced. Specifically, the gas diffusion electrode 133 was the gas diffusion electrode 133 that was a square of 2.7×2.7 cm² and applied with the platinum catalyst (7.3 mg) as the solid catalyst, and was referred to as “GDE-1.”

### <Conditions for Preparation of Catalyst Ink C>

Specifically, the catalyst ink C was prepared using an electrocatalyst as a platinum supported carbon (100.0 mg, produced by TANAKA Kikinzoku Kogyo, platinum content: 46.5 weight %, product name “TEC10E50E”), a Nafion dispersion solution (0.705 g, produced by FUJIFILM Wako Chemicals Corporation, product name “5% Nafion dispersion solution DE520 CS type,” 35.3 mg as Nafion solid content), and 2-propanol (2 mL, produced by FUJIFILM Wako Chemicals Corporation.).

The proportion of the ionomer in the catalyst ink described above will be described. In the catalyst ink C, the proportion of the ionomer (weight %) calculated from the following formula was set to 26 weight %.

### [Electrolytic Apparatus (First)]

A membrane electrode assembly (hereinafter also referred to as an “MEA”) formed of the electrolyte membrane 102, the cathode catalyst layer 103, and the anode catalyst layer 113 was produced as follows. As an ion exchange membrane used for the electrolyte membrane 102, a Nafion 212 membrane (registered trademark) (membrane thickness 50 μm, 5 cm×4 cm) by DuPont was used. The “GDE-Cathode-2” of the gas diffusion electrode 133 as the cathode catalyst layer was disposed on one surface of the ion exchange membrane, and the “GDE-1” of the gas diffusion electrode 133 as the anode catalyst layer was disposed on the other surface of the ion exchange membrane. After that, thermocompression bonding was performed under conditions of a top-bottom plate temperature of 132° C., a load of 5.4 kN, and a thermocompression bonding time of 240 seconds to produce “MEA-1” as the membrane electrode assembly.

Stainless-steel current collectors having 25 circular holes with diameters of 2.5 mm on both surfaces of the obtained MEA “MEA-1” were attached to electrolysis tanks together with Teflon (registered trademark) sheet frames as gaskets to assemble the electrolytic apparatus (first) 100 described in FIG. 1.

### [Electrolytic Apparatus (Third)]

Using the obtained “MEA-1,” the electrolytic apparatus of ammonia (third)300 described in FIG. 3 that did not include a cathode electrolytic solution tank was assembled.

### [Electrolytic Apparatus (Second)]

The production of the electrolytic apparatus of ammonia (second) 200 described in FIG. 2 will be described. As the cathode, a stainless-steel current collector having 25 circular holes with diameters of 2.5 mm was attached to the “GDE-Cathode-2” of the gas diffusion electrode 133 as the cathode catalyst layer. As the anode, as the metal plate electrode 117, a platinum mesh electrode was used. The electrolytic apparatus of ammonia (second) 200 described in FIG. 2 including both electrodes described above was assembled.

### [Electrolytic Apparatus (Fourth)]

The production of the electrolytic apparatus of ammonia (fourth) 400 described in FIG. 4 will be described. The cathode membrane electrode assembly 132 formed of the electrolyte membrane 102 and the cathode catalyst layer 103 was produced as follows. As an ion exchange membrane used for the electrolyte membrane, a Nafion 212 membrane (registered trademark) (membrane thickness 50 μm, 5 cm×4 cm) by DuPont was used. The “GDE-Cathode-2” of the gas diffusion electrode 133 was disposed on one surface of the ion exchange membrane. Thermocompression bonding was performed under conditions of a top-bottom plate temperature of 132° C., a load of 5.4 kN, and thermocompression bonding time of 240 seconds to produce a single-sided membrane electrode assembly “MEA-2” as the cathode membrane electrode assembly 132. As the cathode, a stainless-steel current collector having 25 circular holes with diameters of 2.5 mm was attached to the surface not on the electrolyte membrane side of the “MEA-2.” As the anode, as the metal plate electrode 117, a platinum mesh electrode was used. The electrolytic apparatus of ammonia (fourth) 400 described in FIG. 4 including both electrodes described above was assembled.

2. Production with Electrolytic Apparatus of Ammonia

Using the electrolytic apparatus (first) that produces ammonia assembled as described above, the production of ammonia by electrolysis was performed under the following conditions.
Temperature of the apparatus body: 25 to 28° C. (room temperature)
Power supply device 101: a voltage and a current were measured using Versa STAT4 produced by Princeton Applied Research.
Cathode electrolytic solution tank 105: 0.02 mol/L of a sulfuric acid aqueous solution (6 mL)
Anode electrolytic solution tank 115: 0.02 mol/L of a sulfuric acid aqueous solution (6 mL)
Diluted sulfuric acid aqueous solution tank for trapping ammonia 125: 0.02 mol/L of a sulfuric acid aqueous solution (10 mL)
Measurement condition: a constant potential was measured at −2.3 V.

The Thermo Scientific Dionex ion chromatography (IC) system, Dionex Integrion, produced by Thermo was used for the quantitative determination of ammonia. Amounts of ammonia of the sulfuric acid aqueous solution of the diluted sulfuric acid aqueous solution tank for trapping ammonia 125 and the sulfuric acid aqueous solution of the cathode electrolytic solution tank 105 were quantitated to obtain the amount of generated ammonia. The amount of generated ammonia per the complex in the catalyzer was defined as a catalyst turnover number, and it was calculated by the following formula. Conversion efficiency was calculated from the amount of electricity used of data of Versa STAT4 of the power supply device 101.

$$Catalyst turnover number ( mol / mol ) = [ amount of generated ammonia ( μmol ) / complex ( μmol ) ] ( mol / mol )$$

The following Table 1 shows the results of this test example.

TABLE 1

| Reaction | Amount of Generated | Catalyst Turnover | Conversion |
|---|---|---|---|
| Time (hr) | Ammonia (μmol) | Number (mol/mol) | Efficiency (%) |
| 1 | 0.63 | 15 | 1.02 |
| 2 | 0.76 | 18 | 1.12 |
| 4 | 1.05 | 25 | 0.45 |
| 6 | 1.31 | 31 | 0.32 |

### Comparative Example 1

The electrolytic apparatus of ammonia (first) was produced similarly to Test Example 1 described above except that a rare earth metal-carbon-based binder was not used for the cathode catalyst layer 103, and production of ammonia by electrolysis was performed similarly to Test Example 1. Specifically, the catalyst ink B (10 μL) was applied to the “GDE-1” of the gas diffusion electrode 133 to produce the cathode catalyst layer 103. Specifically, the gas diffusion electrode 133 as the cathode catalyst layer 103 was the gas diffusion electrode 133 that was a square of 2.7×2.7 cm² and applied with the platinum catalyst (7.3 mg) as a solid catalyst and the molybdenum complex (0.058 mg, 0.042 μmol) expressed by Formula (A1-1), and was referred to as “GDE-Cathode-3.” The gas diffusion electrode 133 as the anode catalyst layer 113 was the “GDE-1” similar to Test Example 1. The following Table 2 shows the results.

TABLE 2

| Reaction | Amount of Generated | Catalyst Turnover | Conversion |
|---|---|---|---|
| Time (hr) | Ammonia (μmol) | Number (mol/mol) | Efficiency (%) |
| 1 | 0.33 | 8 | 0.59 |
| 2 | 0.41 | 10 | 0.43 |
| 4 | 0.46 | 11 | 0.27 |
| 6 | 0.51 | 12 | 0.21 |

### Comparative Example 2

The electrolytic apparatus of ammonia (first) 100 was produced similarly to Test Example 1 described above except that the platinum catalyst as the solid catalyst or the rare earth metal-carbon-based binder was not used in the cathode catalyst layer 103, and the production of ammonia by electrolysis was performed similarly to Test Example 1. Specifically, only the catalyst ink B (10 μL) was applied to a carbon paper (produced by Toray Industries, Inc., product name “TGP-H-060H”), and the product was used as the cathode catalyst layer. Specifically, the cathode catalyst layer was the gas diffusion electrode 133 that was a square of 2.7×2.7 cm² and applied with the molybdenum complex (0.058 mg, 0.042 μmol) expressed by Formula (A1-1), and was referred to as “GDE-Cathode-4.” The gas diffusion electrode 133 as the anode catalyst layer 113 was the “GDE-1” similar to Test Example 1. The following Table 3 shows the results.

TABLE 3

| Reaction | Amount of Generated | Catalyst Turnover | Conversion |
|---|---|---|---|
| Time (hr) | Ammonia (μmol) | Number (mol/mol) | Efficiency (%) |
| 1 | 0.21 | 5 | 0.61 |
| 2 | 0.25 | 6 | 0.35 |
| 4 | 0.34 | 8 | 0.31 |
| 6 | 0.38 | 9 | 0.26 |

Table 4 summarizes and shows the results of Test Example 1, Comparative Example 1, and Comparative Example 2.

TABLE 4

| | Test | Comparative | Comparative |
|---|---|---|---|
| Item | Example 1 | Example 1 | Example 2 |
| Complex per | 0.042 | 0.042 | 0.042 |
| Molybdenum [μmol] | | | |
| Solid Catalyst [mg] | 7.3 | 7.3 | — |
| Rare Earth Metal-Carbon- | 12.0 | — | — |
| Based Binder [mg] | | | |
| Catalyst Turnover Number: | 15 (1 hr) | 8 (1 hr) | 5 (1 hr) |
| NH₃/Molybdenum | 18 (2 hr) | 10 (2 hr) | 6 (2 hr) |
| Complex [(mol/mol)] | 25 (4 hr) | 11 (4 hr) | 8 (4 hr) |
| (Reaction Time [hr]) | 31 (6 hr) | 12 (6 hr) | 9 (6 hr) |

### Examination

In comparison between Test Example 1 and Comparative Example 1, in the reaction time of 6 hours, the increase in the amount of generation of 2.6 times that of Comparative Example 1 was recognized in Test Example 1, and the amount of increase of generated ammonia in the reaction time from 4 hours to 6 hours was 600% when Comparative Example 1 was assumed to be 100%. This result shows that the amount of generated ammonia was able to be improved by the catalyst system composed of the molybdenum complex, the solid catalyst, and the rare earth metal-carbon-based binder, and the decrease in the amount of increase of generated ammonia as the reaction time progresses was able to be suppressed.

The result of Comparative Example 2 (only the complex was used for the catalyst) shows that, with only the molybdenum complex, the amount of increase of generated ammonia decreases while the reaction time elapses.

### Test Example 2

The electrolytic apparatus of ammonia (first) 100 was produced similarly to Test Example 1 described above except that “GDE-Cathode-5” described below was used instead of the “GDE-Cathode-2” for the cathode catalyst layer 103, and the production of ammonia by electrolysis was performed similarly to Test Example 1.

The “GDE-Cathode-5” will be specifically described. Except that the rare earth metal-carbon-based binder (b3) was used instead of the rare earth metal-carbon-based binder (b1), the “GDE-Cathode-4” was produced similarly to the “GDE-Cathode-1” in Test Example 1. Next, a solution obtained by dissolving a molybdenum complex expressed by Formula (A1-2)

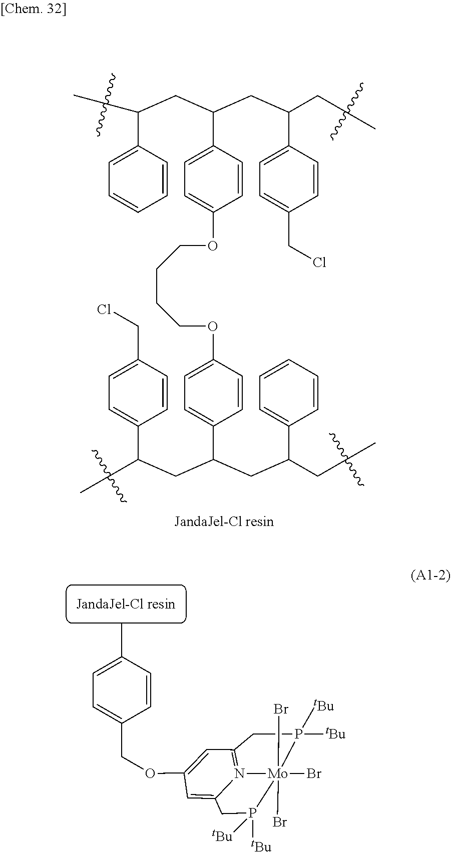

(In 4.3 mg, the number of moles per molybdenum was 1.2 μmol by an ICP emission spectrochemical analysis method) into 1-butyl-3-methylimidazolium bis(trifluoromethanesulfonyl) imide (1.0 mL) instead of the molybdenum complex expressed by Formula (A1-1) was used as catalyst ink D. The molybdenum complex expressed by Formula (A1-2) was synthesized by the method described in Non-Patent Document, Chem. Lett., 2019, Volume 48, Pages 693 to 695. Ink obtained by mixing the catalyst ink D (20 μL) with iodine (2.0 mg) was applied to the “GDE-Cathode-4” as the gas diffusion electrode 133 to produce the cathode catalyst layer 103.

Specifically, the gas diffusion electrode 133 as the cathode catalyst layer 103 was the gas diffusion electrode 133 that was a square of 2.7×2.7 cm² and applied with a platinum catalyst (7.3 mg) as the solid catalyst, the molybdenum complex (0.086 mg, 0.024 μmol per molybdenum) expressed by Formula (A1-2), and iodine (2.0 mg, 7.9 μmol), and was referred to as the “GDE-Cathode-5.” The gas diffusion electrode 133 as the anode catalyst layer 113 was the “GDE-1” similar to Test Example 1. The following Table 5 shows the results.

TABLE 5

| Reaction | Amount of Generated | Catalyst Turnover | Conversion |
|---|---|---|---|
| Time (hr) | Ammonia (μmol) | Number (mol/mol) | Efficiency (%) |
| 1 | 0.86 | 35 | 0.34 |
| 2 | 1.16 | 48 | 0.23 |
| 3 | 1.51 | 63 | 0.20 |
| 6 | 2.11 | 88 | 0.15 |

### Examination

To achieve the effect of improving the catalytic activity of the molybdenum complex by exchanging the bromo ligand of the molybdenum complex expressed by Formula (A1-2) for the iodine ligand and the effect as a mediator, that is, an electron-transfer carrier, in the cathode catalyst layer, the iodine in the cathode catalyst layer 103 was added at the time of producing the “GDE-Cathode-5” as the gas diffusion electrode.

### Test Example 3

In producing the electrolytic apparatus for producing ammonia, the same experimental operation as in Test Example 1 described above was performed to produce the electrolytic apparatus (third). The ammonia was produced by electrolysis using the assembled electrolytic apparatus (third) under the following conditions.
Temperature of the apparatus body: 25 to 28° C. (room temperature)
Power supply device 101: a voltage and a current were measured using Versa STAT4 produced by Princeton Applied Research.
Cathode catalyst layer 103: nitrogen was flowed by 5 mL/minute.
Anode electrolytic solution tank 115: 0.02 mol/L of a sulfuric acid aqueous solution (6 mL)
Diluted sulfuric acid aqueous solution tank for trapping ammonia 125: 0.02 mol/L of a sulfuric acid aqueous solution (10 mL)
Electrolysis condition: a constant potential was measured at −2.3 V.

The cathode catalyst layer was rinsed using 0.02 mol/L of the sulfuric acid aqueous solution (6 mL) by stopping the power supply device every 1 hour of the reaction time. The amount of generated ammonia was obtained by quantifying the amounts of ammonia in the sulfuric acid aqueous solution of the diluted sulfuric acid aqueous solution tank for trapping ammonia 125 and the sulfuric acid aqueous solution used for rinsing the cathode catalyst layer 103. The following Table 6 shows the results of this example.

TABLE 6

| Reaction | Amount of Generated | Catalyst Turnover |
|---|---|---|
| Time (hr) | Ammonia (μmol) | Number (mol/mol) |
| 1 | 0.40 | 10 |
| 2 | 0.65 | 16 |

### Test Example 4

In producing the electrolytic apparatus for producing ammonia, the same experimental operation as in Test Example 1 described above was performed to produce the electrolytic apparatus (fourth). The ammonia was produced by electrolysis using the assembled electrolytic apparatus (fourth) under the following conditions.
Temperature of the apparatus body: 25 to 28° C. (room temperature)
Power supply device 101: a voltage and a current were measured using Versa STAT4 produced by Princeton Applied Research.
Cathode catalyst layer 103: nitrogen was flowed by 5 mL/minute.
Anode electrolytic solution tank 115: 0.02 mol/L of a sulfuric acid aqueous solution (6 mL)
Diluted sulfuric acid aqueous solution tank for trapping ammonia 125: 0.02 mol/L of a sulfuric acid aqueous solution (10 mL)
Electrolysis condition: a constant potential was measured at −2.3 V.

The cathode catalyst layer was rinsed using 0.02 mol/L of the sulfuric acid aqueous solution (6 mL) by stopping the power supply device every 1 hour of the reaction time. The amount of generated ammonia was obtained by quantifying the amounts of ammonia in the sulfuric acid aqueous solution of the diluted sulfuric acid aqueous solution tank for trapping ammonia 125 and the sulfuric acid aqueous solution used for rinsing the cathode catalyst layer 103. The following Table 7 shows the results of this example.

TABLE 7

| Reaction | Amount of Generated | Catalyst Turnover |
|---|---|---|
| Time (hr) | Ammonia (μmol) | Number (mol/mol) |
| 1 | 0.32 | 8 |
| 2 | 0.45 | 11 |

### Synthesis Example 5: Producing Calcined Body (a2)

As the raw material, a mixture (0.41 g) obtained by mixing Ketjenblack EC (produced by Lion Specialty Chemicals Co., Ltd., EC300J, 0.21 g) and 2,3,6,7,10,11-hexahydroxytriphenylene (produced by FUJIFILM Wako Pure Chemical Corporation, 0.21 g) in a mortar was placed in an alumina crucible. The crucible was installed in a desk gas replacement furnace KDF-75 (produced by DENKEN-HIGHDENTAL Co., Ltd.), a nitrogen atmosphere was set in a nitrogen flow, and after that the temperature was increased at a rate of 3° C. per minute, and calcination was performed at a calcining temperature of 400° C. for 2 hours. After the calcination, the product was cooled down to a room temperature while the nitrogen atmosphere was maintained, and the black calcined body (a2) (0.35 g, 85% of it was recovered when the preparation weight was 100%) was obtained.

### Synthesis Example 6: Producing Calcined Body (a3)

The calcined body was produced by the same method as in Synthesis Example 1 except that a mixture (0.63 g) obtained by mixing a carbon nanotube (produced by Showadenkosya Co., Ltd., VGCF (registered trademark)-X, 0.32 g) and phloroglucinol (produced by FUJIFILM Wako Pure Chemical Corporation, 0.32 g) in a mortar was used as a raw material. A black calcined body (0.52 g, 82% of it was recovered when the preparation weight was 100%) was obtained.

### Synthesis Example 7: Producing Rare Earth Metal-Carbon-Based Binder (b4)

A mixture (0.80 g) obtained by mixing the calcined body (a3) (0.40 g) produced in Synthesis Example 6 and tris(acetylacetonato) cerium (III) trihydrate (produced by FUJIFILM Wako Chemical Corporation, 0.40 g) in a mortar was placed in an alumina crucible. The crucible was installed in a desk gas replacement furnace KDF-75 (produced by DENKEN-HIGHDENTAL Co., Ltd.), a nitrogen atmosphere was set in a nitrogen flow, and after that the temperature was increased at a rate of 15° C. per minute, and calcination was performed at the calcining temperature of 350° C. for 1 hour. After the calcination, the product was cooled down to a room temperature while the nitrogen atmosphere was maintained, and the rare earth metal-carbon-based binder (b4) was obtained as black powder (0.51 g, 64% of it was recovered when the preparation weight was 100%) was obtained.

### Test Example 5

The electrolytic apparatus of ammonia (first) was produced similarly to Test Example 1 described above except that the rare earth metal-carbon-based binder (b4) was used for the cathode catalyst layer 103 instead of the rare earth metal-carbon-based binder (b1) and the reaction time of 6 hours was changed to 2 hours, and production of ammonia by electrolysis was performed similarly to Test Example 1. The following Table 8 shows the results of this example.

TABLE 8

| Reaction | Amount of Generated | Catalyst Turnover |
|---|---|---|
| Time (hr) | Ammonia (μmol) | Number (mol/mol) |
| 1 | 0.55 | 13 |
| 2 | 0.71 | 17 |

### Test Example 6

The electrolytic apparatus of ammonia (first) was produced similarly to Test Example 1 described above except that the calcined body (a1) was used instead of the rare earth metal-carbon-based binder (b1) for the cathode catalyst layer 103 and the reaction time of 6 hours was changed to 1 hour, and production of ammonia by electrolysis was performed similarly to Test Example 1. The following Table 9 shows the results of this example.

TABLE 9

| Reaction | Amount of Generated | Catalyst Turnover |
|---|---|---|
| Time (hr) | Ammonia (μmol) | Number (mol/mol) |
| 1 | 0.51 | 12 |
| 2 | 0.69 | 17 |

### INDUSTRIAL APPLICABILITY

The present invention is usable for the ammonia production method.

### REFERENCE SIGNS LIST

100 Electrolytic apparatus of ammonia (first)
101 Power supply device
102 Electrolyte membrane
103 Cathode catalyst layer (catalyst layer that produces ammonia)
104 Cathode current collector
105 Cathode electrolytic solution tank
106 Cathode electrolytic solution
108 Cathode (cathode catalyst layer and cathode current collector)
113 Anode catalyst layer
114 Anode current collector
115 Anode electrolytic solution tank
116 Anode electrolytic solution
117 Metal plate electrode
118 Anode (anode catalyst layer and anode current collector or metal plate electrode)
121 Pipe
122 Nitrogen cylinder
123 Regulator of nitrogen cylinder
124 Mass flow controller of nitrogen gas
125 Diluted sulfuric acid aqueous solution tank for trapping ammonia
126 Draft device
131 Membrane electrode assembly
132 Cathode membrane electrode assembly
133 Gas diffusion electrode
141 Electrolytic cell
200 Electrolytic apparatus of ammonia (second)
300 Electrolytic apparatus of ammonia (third)
400 Electrolytic apparatus of ammonia (fourth)

1. An ammonia production method that produces ammonia from nitrogen molecules by donating electrons from a power supply, protons from a proton source, and the nitrogen molecules from means for supplying a nitrogen gas in presence of a complex, a solid catalyst, and a reaction field forming material in a cathode by a production apparatus for performing electrolysis, wherein
the complex is:
(A) a molybdenum complex having 2,6-bis(dialkylphosphinomethyl) pyridine (where two alkyl groups may be identical or different, and at least one hydrogen atom on a pyridine ring may be substituted with an alkyl group, an alkoxy group, or a halogen atom) as a PNP ligand;
(B) a molybdenum complex having N,N-bis(dialkylphosphinomethyl) dihydrobenzimidazolidene (where two alkyl groups may be identical or different, and at least one hydrogen atom on a benzene ring may be substituted with an alkyl group, an alkoxy group, or a halogen atom) as a PCP ligand;
(C) a molybdenum complex having bis(dialkylphosphinoethyl) arylphosphine (where two alkyl groups may be identical or different) as a PPP ligand; or
(D) a molybdenum complex expressed as trans-Mo(N₂)₂(R⁵R⁶R⁷P)₄ (where R⁵ and R⁶ are aryl groups that may be identical or different, R⁷ is an alkyl group, and two R⁷ groups may be connected with one another to form an alkylene chain),
the solid catalyst is a metal catalyst or an oxide catalyst,
the reaction field forming material is a rare earth metal-carbon-based binder, and
the proton source is an electrolyte membrane, an electrolytic solution, or both of the electrolyte membrane and the electrolytic solution.

2. The ammonia production method according to claim 1, wherein
the molybdenum complex (A) is a molybdenum complex expressed by the following Formula (A1), (A2), or (A3): 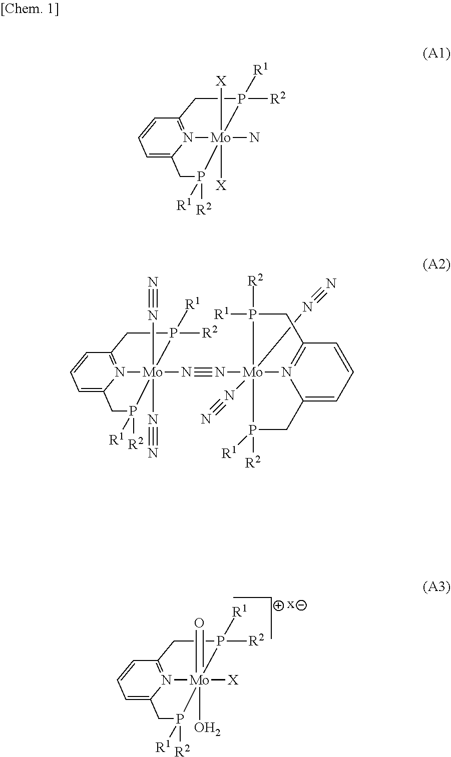
(In the formula, R¹ and R² are alkyl groups that may be identical or different, X is an iodine atom, a bromine atom, or a chlorine atom, and at least one hydrogen atom on a pyridine ring may be substituted with an alkyl group, an alkoxy group, or a halogen atom).

3. The ammonia production method according to claim 1, wherein
the molybdenum complex (B) is a molybdenum complex expressed by the following Formula (B1) or (B2): 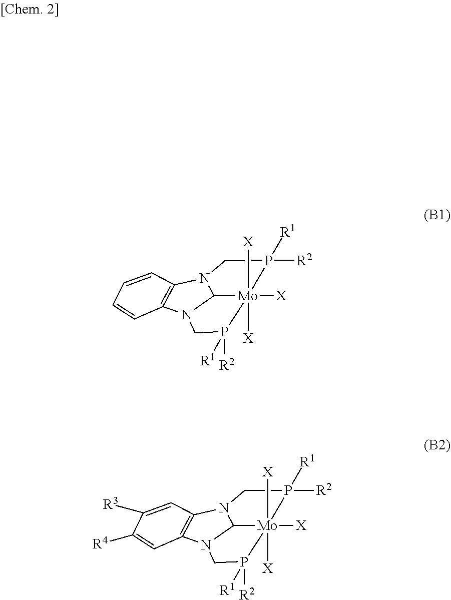
(In the formula, R¹ and R² are alkyl groups that may be identical or different, X is an iodine atom, a bromine atom, or a chlorine atom, at least one hydrogen atom on a benzene ring may be substituted with an alkyl group, an alkoxy group, or a halogen atom, and at least one of R³ and R⁴ is substituted with a trifluoromethyl group).

4. The ammonia production method according to claim 1, wherein
the molybdenum complex (C) is a molybdenum complex expressed by Formula (C₁): 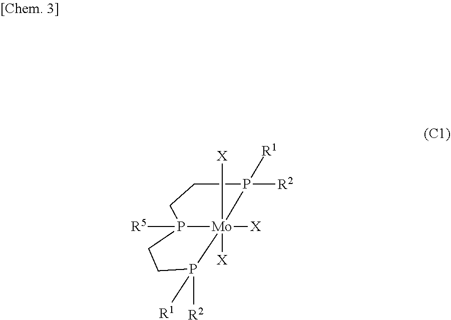
(In the formula, R¹ and R² are alkyl groups that may be identical or different, R⁵ is an aryl group, and X is an iodine atom, a bromine atom, or a chlorine atom).

5. The ammonia production method according to claim 1, wherein
the molybdenum complex (D) is a molybdenum complex expressed by Formula (D1) or (D2): 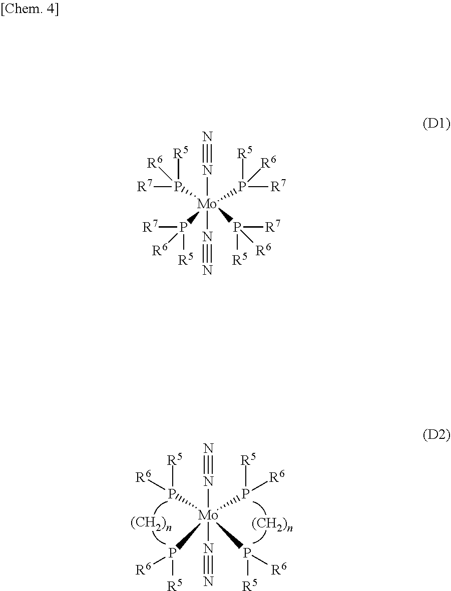
(In the formula, R⁵ and R⁶ are aryl groups that may be identical or different, R⁷ is an alkyl group, and n is 2 or 3).

6. The ammonia production method according to claim 1, wherein
the solid catalyst is a platinum catalyst or a palladium catalyst.

7. A membrane electrode assembly in which an electrolyte membrane is sandwiched between a cathode catalyst layer and an anode catalyst layer to assemble together, wherein
the cathode catalyst layer contains a complex, a cathode solid catalyst, and a reaction field forming material,
the anode catalyst layer contains an anode solid catalyst,
the complex is:
(A) a molybdenum complex having 2,6-bis(dialkylphosphinomethyl) pyridine (where two alkyl groups may be identical or different, and at least one hydrogen atom on a pyridine ring may be substituted with an alkyl group, an alkoxy group, or a halogen atom) as a PNP ligand;
(B) a molybdenum complex having N,N-bis(dialkylphosphinomethyl) dihydrobenzimidazolidene (where two alkyl groups may be identical or different, and at least one hydrogen atom on a benzene ring may be substituted with an alkyl group, an alkoxy group, or a halogen atom) as a PCP ligand;
(C) a molybdenum complex having bis(dialkylphosphinoethyl) arylphosphine (where two alkyl groups may be identical or different) as a PPP ligand; or
(D) a molybdenum complex expressed as trans-Mo(N₂)₂(R⁵R⁶R⁷P)₄ (where R⁵ and R⁶ are aryl groups that may be identical or different, R⁷ is an alkyl group, and two R⁷ groups may be connected with one another to form an alkylene chain),
the cathode solid catalyst and the anode solid catalyst are metal catalysts or oxide catalysts, and
the reaction field forming material is a rare earth metal-carbon-based binder.

8. The membrane electrode assembly according to claim 7, wherein
the molybdenum complex (A) is a molybdenum complex expressed by the following Formula (A1), (A2), or (A3): 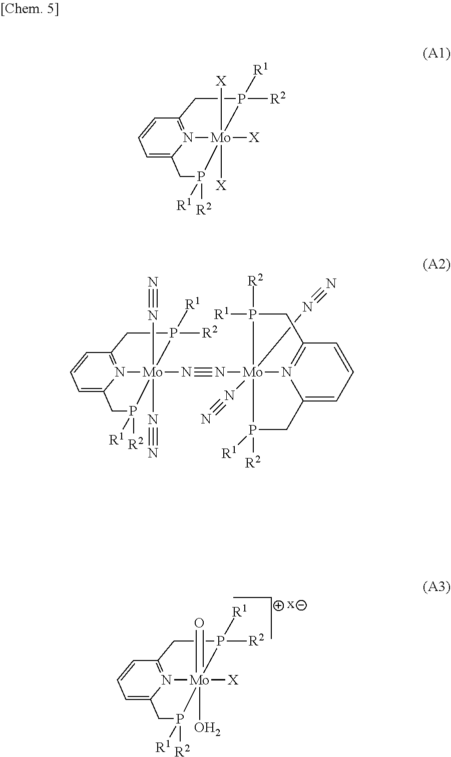
(In the formula, R¹ and R² are alkyl groups that may be identical or different, X is an iodine atom, a bromine atom, or a chlorine atom, and at least one hydrogen atom on a pyridine ring may be substituted with an alkyl group, an alkoxy group, or a halogen atom).

9. The membrane electrode assembly according to claim 7, wherein
the molybdenum complex (B) is a molybdenum complex expressed by the following Formula (B1) or (B2): 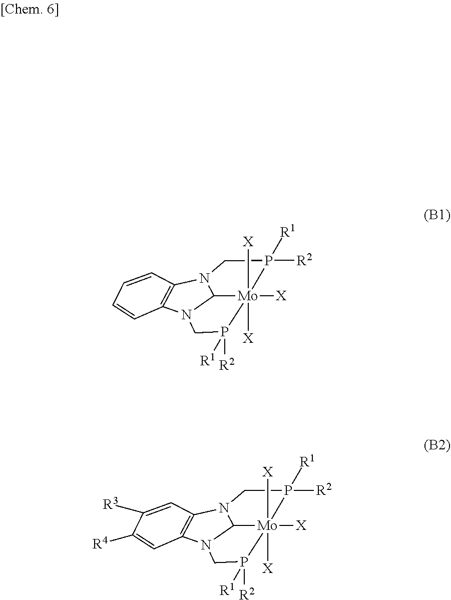
(In the formula, R¹ and R² are alkyl groups that may be identical or different, X is an iodine atom, a bromine atom, or a chlorine atom, at least one hydrogen atom on a benzene ring may be substituted with an alkyl group, an alkoxy group, or a halogen atom, and at least one of R³ and R⁴ is substituted with a trifluoromethyl group).

10. The membrane electrode assembly according to claim 7, wherein
the molybdenum complex (C) is a molybdenum complex expressed by Formula (C1): 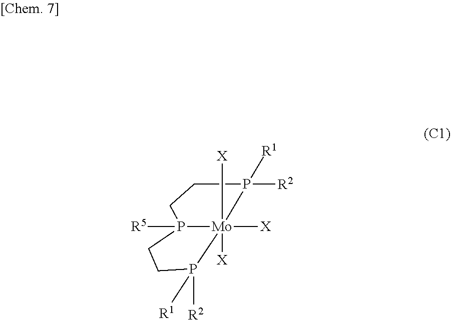
(In the formula, R¹ and R² are alkyl groups that may be identical or different, R⁵ is an aryl group, and X is an iodine atom, a bromine atom, or a chlorine atom).

11. The membrane electrode assembly according to claim 7, wherein
the molybdenum complex (D) is a molybdenum complex expressed by Formula (D1) or (D2): 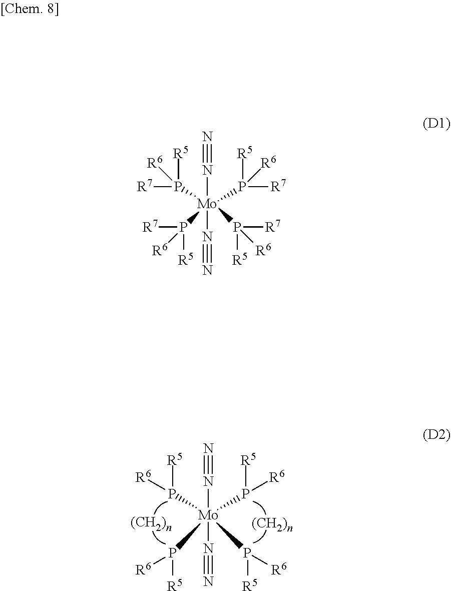
(In the formula, R⁵ and R⁶ are aryl groups that may be identical or different, R⁷ is an alkyl group, and n is 2 or 3).

12. The membrane electrode assembly according to claim 7, wherein
the cathode solid catalyst is a platinum catalyst or a palladium catalyst.

13. An ammonia production apparatus comprising
the membrane electrode assembly according to claim 7 that includes the cathode catalyst layer, the electrolyte membrane, and the anode catalyst layer, wherein
in a cathode, the cathode catalyst layer is assembled to one side of the electrolyte membrane and a cathode current collector is disposed outside the cathode catalyst layer, and in an anode, the anode catalyst layer is assembled to the other side of the electrolyte membrane and an anode current collector is disposed outside the anode catalyst layer,
the cathode includes the cathode catalyst layer and the cathode current collector,
the anode includes the anode catalyst layer and the anode current collector, wherein
the ammonia production apparatus comprises:
a cathode electrolytic solution tank in liquid contact with the cathode;
an anode electrolytic solution tank in liquid contact with the anode;
a power supply that supplies the cathode with electrons;
a proton source that supplies the cathode with protons; and
means that supplies a cathode electrolytic solution or the cathode with a nitrogen gas, wherein
the proton source is the electrolyte membrane, an anode electrolytic solution, or both of the electrolyte membrane and the anode electrolytic solution, and
ammonia is produced from nitrogen molecules by electrolysis.

14. An ammonia production apparatus comprising
the membrane electrode assembly according to claim 7 that includes the cathode catalyst layer, the electrolyte membrane, and the anode catalyst layer, wherein
in a cathode, the cathode catalyst layer is assembled to one side of the electrolyte membrane and a cathode current collector is disposed outside the cathode catalyst layer, and in an anode, the anode catalyst layer is assembled to the other side of the electrolyte membrane and an anode current collector is disposed outside the anode catalyst layer,
the cathode includes the cathode catalyst layer and the cathode current collector,
the anode includes the anode catalyst layer and the anode current collector, wherein
the ammonia production apparatus comprises:
an anode electrolytic solution tank of an anode electrolytic solution in liquid contact with the anode of the membrane electrode assembly;
a power supply that supplies the cathode with electrons;
a proton source that supplies the cathode with protons; and
means that supplies the cathode with a nitrogen gas, wherein
the proton source is the electrolyte membrane, an electrolytic solution, or both of the electrolyte membrane and the electrolytic solution, and
ammonia is produced from nitrogen molecules by electrolysis.

15. A gas diffusion electrode containing a complex and a cathode solid catalyst, wherein
the complex is:
(A) a molybdenum complex having 2,6-bis(dialkylphosphinomethyl) pyridine (where two alkyl groups may be identical or different, and at least one hydrogen atom on a pyridine ring may be substituted with an alkyl group, an alkoxy group, or a halogen atom) as a PNP ligand;
(B) a molybdenum complex having N,N-bis(dialkylphosphinomethyl) dihydrobenzimidazolidene (where two alkyl groups may be identical or different, and at least one hydrogen atom on a benzene ring may be substituted with an alkyl group, an alkoxy group, or a halogen atom) as a PCP ligand;
(C) a molybdenum complex having bis(dialkylphosphinoethyl) arylphosphine (where two alkyl groups may be identical or different) as a PPP ligand; or
(D) a molybdenum complex expressed as trans-Mo(N₂)₂(R⁵R⁶R⁷P)₄ (where R⁵ and R⁶ are aryl groups that may be identical or different, R⁷ is an alkyl group, and two R⁷ groups may be connected with one another to form an alkylene chain),
the cathode solid catalyst is a metal catalyst or an oxide catalyst, and
the reaction field forming material is a rare earth metal-carbon-based binder.

16. The gas diffusion electrode according to claim 15, wherein
the molybdenum complex (A) is a molybdenum complex expressed by the following Formula (A1), (A2), or (A3): 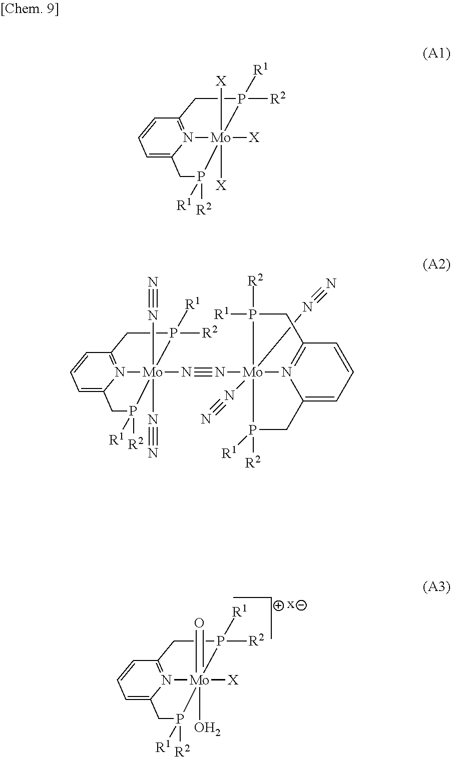
(In the formula, R¹ and R² are alkyl groups that may be identical or different, X is an iodine atom, a bromine atom, or a chlorine atom, and at least one hydrogen atom on a pyridine ring may be substituted with an alkyl group, an alkoxy group, or a halogen atom).

17. The gas diffusion electrode according to claim 15, wherein
the molybdenum complex (B) is a molybdenum complex expressed by the following Formula (B1) or (B2): 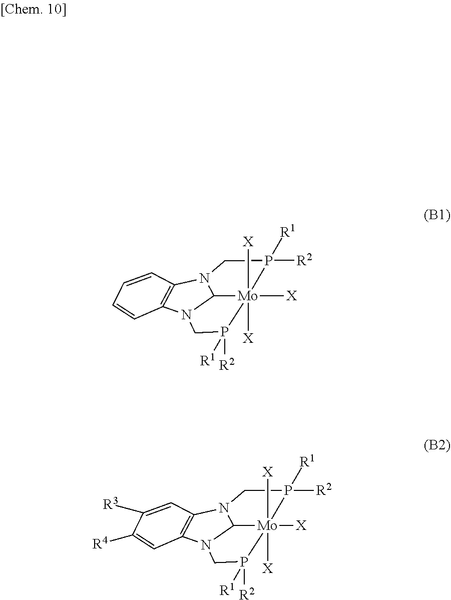
(In the formula, R¹ and R² are alkyl groups that may be identical or different, X is an iodine atom, a bromine atom, or a chlorine atom, at least one hydrogen atom on a benzene ring may be substituted with an alkyl group, an alkoxy group, or a halogen atom, and at least one of R³ and R⁴ is substituted with a trifluoromethyl group).

18. The gas diffusion electrode according to claim 15, wherein
the molybdenum complex (C) is a molybdenum complex expressed by Formula (C1): 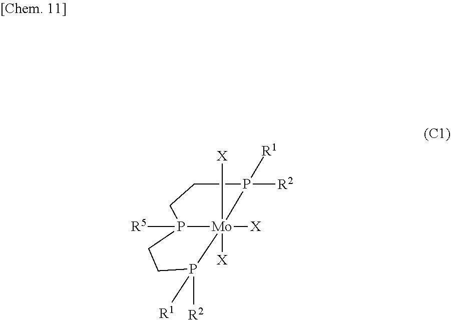
(In the formula, R¹ and R² are alkyl groups that may be identical or different, R⁵ is an aryl group, and X is an iodine atom, a bromine atom, or a chlorine atom).

19. The gas diffusion electrode according to claim 15, wherein
the molybdenum complex (D) is a molybdenum complex expressed by Formula (D1) or (D2): 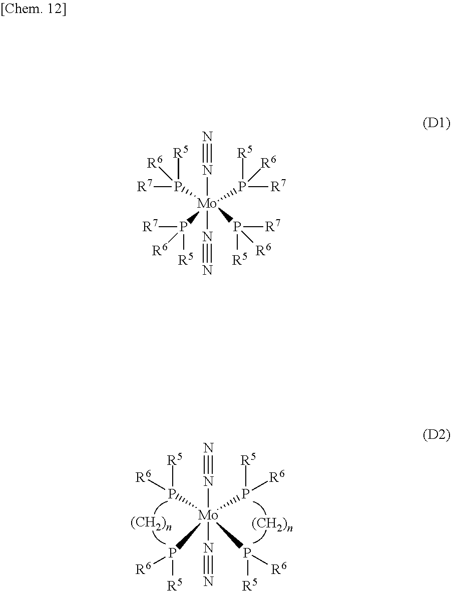
(In the formula, R⁵ and R⁶ are aryl groups that may be identical or different, R⁷ is an alkyl group, and n is 2 or 3).

20. The gas diffusion electrode according to any claim 15, wherein
the cathode solid catalyst is a platinum catalyst or a palladium catalyst.

21. An ammonia production apparatus comprising:
the gas diffusion electrode as the cathode catalyst layer according to claim 15;
a tank of an electrolytic solution in which a cathode current collector is disposed at one side of the cathode catalyst layer as the gas diffusion electrode, the electrolytic solution tank being in liquid contact with the cathode catalyst layer;
a cathode that includes the cathode catalyst layer and the cathode current collector;
an anode that includes a metal plate electrode;
a power supply that supplies the cathode with electrons;
a proton source that supplies the cathode with protons; and
means that supplies the electrolytic solution or the cathode with a nitrogen gas, wherein
the proton source is an electrolytic solution, and
ammonia is produced from nitrogen molecules by electrolysis.

22. A cathode membrane electrode assembly in which a cathode catalyst layer is assembled to one side of an electrolyte membrane, wherein
the cathode catalyst layer contains a complex, a cathode solid catalyst, and a reaction field forming material,
the complex is:
(A) a molybdenum complex having 2,6-bis(dialkylphosphinomethyl) pyridine (where two alkyl groups may be identical or different, and at least one hydrogen atom on a pyridine ring may be substituted with an alkyl group, an alkoxy group, or a halogen atom) as a PNP ligand;
(B) a molybdenum complex having N,N-bis(dialkylphosphinomethyl) dihydrobenzimidazolidene (where two alkyl groups may be identical or different, and at least one hydrogen atom on a benzene ring may be substituted with an alkyl group, an alkoxy group, or a halogen atom) as a PCP ligand;
(C) a molybdenum complex having bis(dialkylphosphinoethyl) arylphosphine (where two alkyl groups may be identical or different) as a PPP ligand; or
(D) a molybdenum complex expressed as trans-Mo(N₂)₂(R⁵R⁶R⁷P)₄ (where R⁵ and R⁶ are aryl groups that may be identical or different, R⁷ is an alkyl group, and two R⁷ groups may be connected with one another to form an alkylene chain), and
the cathode solid catalyst is a metal catalyst or an oxide catalyst.

23. The cathode membrane electrode assembly according to claim 22, wherein
the molybdenum complex (A) is a molybdenum complex expressed by the following Formula (A1), (A2), or (A3): 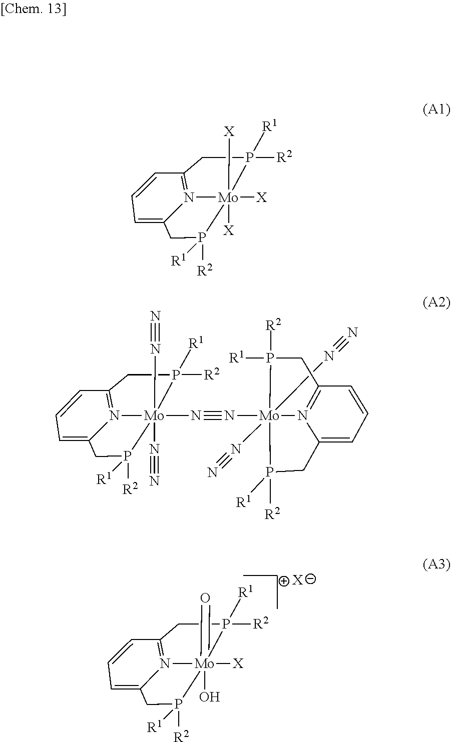
(In the formula, R¹ and R² are alkyl groups that may be identical or different, X is an iodine atom, a bromine atom, or a chlorine atom, and at least one hydrogen atom on a pyridine ring may be substituted with an alkyl group, an alkoxy group, or a halogen atom).

24. The cathode membrane electrode assembly according to claim 22, wherein
the molybdenum complex (B) is a molybdenum complex expressed by the following Formula (B1) or (B2): 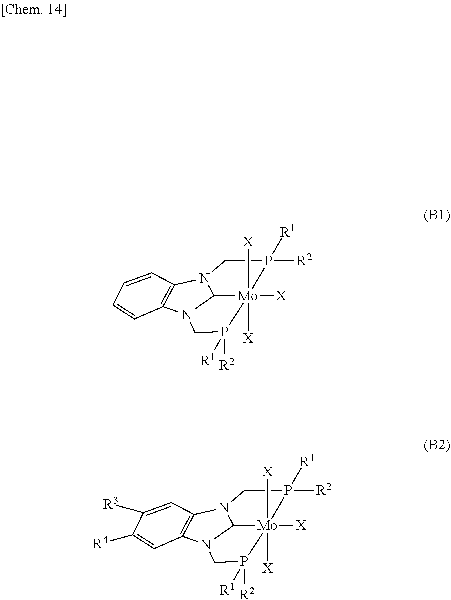
(In the formula, R¹ and R² are alkyl groups that may be identical or different, X is an iodine atom, a bromine atom, or a chlorine atom, at least one hydrogen atom on a benzene ring may be substituted with an alkyl group, an alkoxy group, or a halogen atom, and at least one of R³ and R⁴ is substituted with a trifluoromethyl group).

25. The cathode membrane electrode assembly according to claim 22, wherein
the molybdenum complex (C) is a molybdenum complex expressed by Formula (C1): 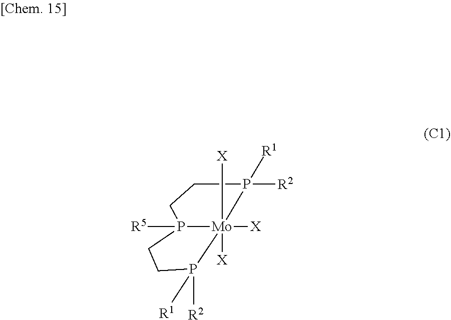
(In the formula, R¹ and R² are alkyl groups that may be identical or different, R⁵ is an aryl group, and X is an iodine atom, a bromine atom, or a chlorine atom).

26. The cathode membrane electrode assembly according to claim 22, wherein
the molybdenum complex (D) is a molybdenum complex expressed by Formula (D1) or (D2): 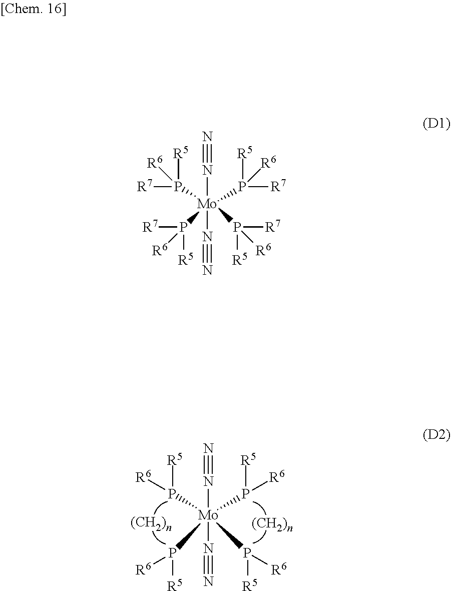
(In the formula, R⁵ and R⁶ are aryl groups that may be identical or different, R⁷ is an alkyl group, and n is 2 or 3).

27. The cathode membrane electrode assembly according to claim 22, wherein
the cathode solid catalyst is a platinum catalyst or a palladium catalyst.

28. An ammonia production apparatus comprising:
the cathode membrane electrode assembly according to claim 22 in which the cathode catalyst layer is assembled to one side of the electrolyte membrane;
a cathode current collector disposed on a side opposite to the electrolyte membrane of the cathode catalyst layer;
a cathode that includes the cathode catalyst layer and the cathode current collector;
a tank of an electrolytic solution in liquid contact with the electrolyte membrane;
an anode that includes a metal plate electrode;
a power supply that supplies the cathode with electrons;
a proton source that supplies the cathode with protons; and
means that supplies the electrolytic solution or the cathode with a nitrogen gas, wherein
the proton source is the electrolyte membrane, an electrolytic solution, or both of the electrolyte membrane and the electrolytic solution, and
ammonia is produced from nitrogen molecules by electrolysis.
